(19) United States
(12) Patent Application Publication
(10) Pub. No.: US 2026/0313490 A1
(43) Pub. Date: Oct. 8, 2026

(54) TRANSMISSION CONFIGURATION INDICATOR ASSOCIATION WITH CANDIDATE CELL SYNCHRONIZATION SIGNAL BLOCKS

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/483,217

(22) PCT Filed: Jun. 28, 2024
(86) PCT No.: PCT/CN2024/102255

§ 371 Date: Nov. 10, 2025

(30) Foreign Application Priority Data
Jul. 14, 2023 (WO) PCT/CN2023/107421

(51) Int. Cl. H04W 36/00; H04B 7/06; H04W 56/00

(52) U.S. Cl. CPC H04W 36/00835; H04B 7/06968; H04W 36/0016; H04W 56/0015

(57) ABSTRACT

Methods, systems, and devices for wireless communications are described. A user equipment (UE) may be configured to receive, via a serving cell, an indication of a transmission configuration indicator (TCI) state for communicating with a candidate cell, wherein the TCI state is associated with a quasi co-location (QCL) source that indicates that spatial resources used by the UE for communications with the candidate cell are QCLed with a reference signal of the candidate cell. The UE may receive, via the serving cell, first control information that is indicative of an association between the TCI state and first resources for receipt of a synchronization signal block (SSB) from the candidate cell. The UE may then communicate one or more messages with the candidate cell using the spatial resources, where the spatial resources are based at least in part on the association between the first resources and the TCI state.

### CROSS REFERENCE

The present Application for Patent is a 371 national phase filing of International Patent Application No. PCT/CN2024/102255 by YUAN et al., entitled “TRANSMISSION CONFIGURATION INDICATOR ASSOCIATION WITH CANDIDATE CELL SYNCHRONIZATION SIGNAL BLOCKS,” filed Jun. 28, 2024, which claims priority to International Patent Application No. PCT/CN2023/107421 by YUAN et al., entitled “TRANSMISSION CONFIGURATION INDICATOR ASSOCIATION WITH CANDIDATE CELL SYNCHRONIZATION SIGNAL BLOCKS,” filed Jul. 14, 2023, each of which is assigned to the assignee hereof, and each of which is expressly incorporated by reference in its entirety herein.

### TECHNICAL FIELD

The following relates to wireless communications, including techniques for transmission configuration indicator (TCI) association with candidate cell synchronization signal blocks (SSBs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless devices, such as UEs, may switch between serving cells as the wireless devices move within a wireless network. UEs may be configured to perform measurements of reference signals from other cells in order to identify candidate cells for cell switch/handover procedures. When moving from a first cell (e.g., current, source cell) to a second cell (e.g., target, candidate cell), the first cell may indicate a transmission configuration indicator (TCI) state that the UE is to use for communicating with the second cell. Additionally, the first cell may indicate a reference signal (e.g., channel state information reference signal (CSI-RS)) that serves as a quasi co-location (QCL) source for communications performed using the indicated TCI state.

### SUMMARY

The described techniques relate to improved methods, systems, devices, and apparatuses that support transmission configuration indicator (TCI) association with candidate cell synchronization signal blocks (SSBs). Generally, aspects of the present disclosure are directed to techniques that enable SSBs to serve as a quasi co-location (QCL) source for TCI states. In particular, aspects of the present disclosure are directed to signaling and configurations that enable user equipments (UEs) to derive QCL properties for a TCI state from an SSB even when the TCI state specifies a channel state information reference signal (CSI-RS) as its QCL source. For example, when evaluating a switch from a first cell to a second cell, a UE may receive an indication of a TCI state for communicating with the second cell, where the TCI state indicates a CSI-RS as the QCL source for the TCI state. In this example, aspects of the present disclosure may provide some “linkage” between the TCI state and/or the CSI-RS and an SSB so that the UE can use the linked SSB as the QCL source for the TCI state. For instance, a radio resource control (RRC) message may indicate a TCI state list with corresponding CSI-RSs and SSBs for each respective TCI state. As such, the UE may use some linkage information to derive the appliable SSB of the second cell, where the identified SSB is used as the QCL source for the activated TCI state. After switching from the first cell to the second cell, the UE may determine when to revert back to using the applicable CSI-RS as the QCL source, such as based on explicit signaling from the network or based on an expiration of a timer.

A method by a UE is described. The method may include receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell, receiving, via the serving cell, first control information that is indicative of an association between the TCI state and first resources for receipt of an SSB from the candidate cell, and communicating one or more messages with the candidate cell using the spatial resources, where the spatial resources are based on the association between the first resources and the TCI state.

A UE is described. The UE may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the UE to receive, via a serving cell, an indication of a TCI state for communicating with a candidate cell, where the TCI state is associated with a QCL source that indicates that spatial resources used by the UE for communications with the candidate cell are QCLed with a reference signal of the candidate cell, receive, via the serving cell, first control information that is indicative of an association between the TCI state and first resources for receipt of an SSB from the candidate cell, and communicate one or more messages with the candidate cell using the spatial resources, where the spatial resources are based on the association between the first resources and the TCI state.

Another UE is described. The UE may include means for receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell, means for receiving, via the serving cell, first control information that is indicative of an association between the TCI state and first resources for receipt of an SSB from the candidate cell, and means for communicating one or more messages with the candidate cell using the spatial resources, where the spatial resources are based on the association between the first resources and the TCI state.

A non-transitory computer-readable medium storing code is described. The code may include instructions executable by a processor to receive, via a serving cell, an indication of a TCI state for communicating with a candidate cell, where the TCI state is associated with a QCL source that indicates that spatial resources used by the UE for communications with the candidate cell are QCLed with a reference signal of the candidate cell, receive, via the serving cell, first control information that is indicative of an association between the TCI state and first resources for receipt of an SSB from the candidate cell, and communicate one or more messages with the candidate cell using the spatial resources, where the spatial resources are based on the association between the first resources and the TCI state.

In some examples of the method, UE, and non-transitory computer-readable medium described herein, the one or more messages may be communicated in accordance with the TCI state and using the SSB as the QCL source for the TCI state based on the first control information.

In some examples of the method, UE, and non-transitory computer-readable medium described herein, the one or more messages may be communicated using the spatial resources that may be QCLed with the first resources for receipt of the SSB from the candidate cell based on the first control information.

Some examples of the method, UE, and non-transitory computer-readable medium described herein may further include operations, features, means, or instructions for receiving an RRC message that indicates the association between the TCI state and the first resources for receipt of the SSB, where the TCI state may be one of a set of TCI states included in the RRC message, each of the set of TCI states having corresponding sets of resources for receipt of one or more SSBs.

Some examples of the method, UE, and non-transitory computer-readable medium described herein may further include operations, features, means, or instructions for receiving an RRC message indicating an additional association between the reference signal and the SSB, where the first control information may be received via the RRC message, and where the association between the first resources and the TCI state may be based on the additional association between the reference signal and the SSB.

In some examples of the method, UE, and non-transitory computer-readable medium described herein, the first resources for receipt of the SSB include a downlink frequency resource, an SSB subcarrier spacing (SCS), a physical cell identifier (PCID), an SSB index, or any combination thereof.

In some examples of the method, UE, and non-transitory computer-readable medium described herein, the first control information may be received via an RRC message and the RRC message further indicates a TCI type associated with the TCI state for the candidate cell.

Some examples of the method, UE, and non-transitory computer-readable medium described herein may further include operations, features, means, or instructions for receiving a cell switch command indicating for the UE to switch from the serving cell to the candidate cell, where the cell switch command includes the first control information.

In some examples of the method, UE, and non-transitory computer-readable medium described herein, the cell switch command includes a medium access control-control element (MAC-CE) message.

In some examples of the method, UE, and non-transitory computer-readable medium described herein, the cell switch command further includes an activation of the TCI state for the candidate cell.

Some examples of the method, UE, and non-transitory computer-readable medium described herein may further include operations, features, means, or instructions for receiving second control information that may be indicative of the TCI state and a downlink control channel order associated with a set of random access occasions, and where the set of random access occasions correspond to a set of SSBs including the SSB, transmitting, based on receiving the second control information, a first random access message via a random access occasion of the set of random access occasions, where the random access occasion corresponds to the SSB, and receiving a second random access message in response to the first random access message, where the second random access message includes the first control information that may be indicative of the association between the TCI state and first resources for receipt of the SSB.

Some examples of the method, UE, and non-transitory computer-readable medium described herein may further include operations, features, means, or instructions for receiving second control information indicating a set of timing advance (TA) values and corresponding sets of resources for receipt of SSBs, where the sets of resources include the first resources and receiving a cell switch command including the indication of the TCI state and an indication of a TA value from the set of TA values, where the first control information may be based on the indicated TA value corresponding to the first resources for receipt of the SSB indicated via the second control information.

Some examples of the method, UE, and non-transitory computer-readable medium described herein may further include operations, features, means, or instructions for receiving, via the serving cell, an indication of a channel state information configuration for the reference signal of the candidate cell, where the first resources include a root QCL source associated with the reference signal, where the reference signal may be a CSI-RS.

Some examples of the method, UE, and non-transitory computer-readable medium described herein may further include operations, features, means, or instructions for receiving, via the candidate cell, a control message indicating the reference signal of the candidate cell and communicating one or more additional messages with the candidate cell using the reference signal as the QCL source based on receiving the control message.

Some examples of the method, UE, and non-transitory computer-readable medium described herein may further include operations, features, means, or instructions for receiving, via the serving cell, a cell switch command indicating for the UE to switch from the serving cell to the candidate cell, where the one or more messages may be communicated using the SSB as the QCL source for the TCI state based on the first control information and the cell switch command, identifying an expiration of a timer based on receiving the cell switch command, and communicating one or more additional messages with the candidate cell using the reference signal as the QCL source based on identifying the expiration of the timer.

Some examples of the method, UE, and non-transitory computer-readable medium described herein may further include operations, features, means, or instructions for receiving, via the serving cell, the candidate cell, or both, an indication of the timer, where identifying the expiration of the timer may be based on receiving the indication of the timer.

In some examples of the method, UE, and non-transitory computer-readable medium described herein, the indication of the TCI state and the first control information may be received via a same control message.

In some examples of the method, UE, and non-transitory computer-readable medium described herein, the QCL source indicates that the spatial resources used by the UE for communications with the candidate cell may be QCLed with a channel-state information reference signal of the candidate cell.

A method by a UE is described. The method may include receiving, via a serving cell, an indication of a TCI state for communicating with a candidate cell, where the TCI state is associated with a QCL source that indicates that spatial resources used by the UE for communications with the candidate cell are QCLed with an SSB of the candidate cell and communicating one or more messages with the candidate cell using the spatial resources, where the spatial resources are based on measurements of the SSB.

A UE for wireless communication is described. The UE may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the UE to receive, via a serving cell, an indication of a TCI state for communicating with a candidate cell, where the TCI state is associated with a QCL source that indicates that spatial resources used by the UE for communications with the candidate cell are QCLed with an SSB of the candidate cell and communicate one or more messages with the candidate cell using the spatial resources, where the spatial resources are based on measurements of the SSB.

Another UE is described. The UE may include means for receiving, via a serving cell, an indication of a TCI state for communicating with a candidate cell, where the TCI state is associated with a QCL source that indicates that spatial resources used by the UE for communications with the candidate cell are QCLed with an SSB of the candidate cell and means for communicating one or more messages with the candidate cell using the spatial resources, where the spatial resources are based on measurements of the SSB.

A non-transitory computer-readable medium storing code is described. The code may include instructions executable by a processor to receive, via a serving cell, an indication of a TCI state for communicating with a candidate cell, where the TCI state is associated with a QCL source that indicates that spatial resources used by the UE for communications with the candidate cell are QCLed with an SSB of the candidate cell and communicate one or more messages with the candidate cell using the spatial resources, where the spatial resources are based on measurements of the SSB.

Some examples of the method, UE, and non-transitory computer-readable medium described herein may further include operations, features, means, or instructions for receiving, from the serving cell, a cell switch command indicating for the UE to switch from the serving cell to the candidate cell, where communicating the one or more messages may be based on receiving the cell switch command.

In some examples of the method, UE, and non-transitory computer-readable medium described herein, the indication of the TCI state may be received via the cell switch command.

Some examples of the method, UE, and non-transitory computer-readable medium described herein may further include operations, features, means, or instructions for receiving an RRC message indicating associations between a set of TCI states and sets of resources for receipt of SSBs, where the set of TCI states include the indicated TCI state, and where the sets of resources include first resources associated with the SSB, where receiving the indication of the TCI state may be based on receiving the RRC message.

A method for wireless communications by a network entity is described. The method may include transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell, transmitting, via the serving cell, first control information that is indicative of an association between the TCI state and first resources for transmission of an SSB from the candidate cell, and communicating one or more messages with the UE via the candidate cell using the spatial resources, where the spatial resources are based on the association between the first resources and the TCI state.

A network entity for wireless communication is described. The network entity may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the network entity to transmit, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell, transmit, via the serving cell, first control information that is indicative of an association between the TCI state and first resources for transmission of an SSB from the candidate cell, and communicate one or more messages with the UE via the candidate cell using the spatial resources, where the spatial resources are based on the association between the first resources and the TCI state.

Another network entity for wireless communications is described. The network entity may include means for transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell, means for transmitting, via the serving cell, first control information that is indicative of an association between the TCI state and first resources for transmission of an SSB from the candidate cell, and means for communicating one or more messages with the UE via the candidate cell using the spatial resources, where the spatial resources are based on the association between the first resources and the TCI state.

A non-transitory computer-readable medium storing code for wireless communications is described. The code may include instructions executable by a processor to transmit, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell, transmit, via the serving cell, first control information that is indicative of an association between the TCI state and first resources for transmission of an SSB from the candidate cell, and communicate one or more messages with the UE via the candidate cell using the spatial resources, where the spatial resources are based on the association between the first resources and the TCI state.

In some examples of the method, network entities, and non-transitory computer-readable medium described herein, the one or more messages may be communicated in accordance with the TCI state and using the SSB as the QCL source for the TCI state based on the first control information.

In some examples of the method, network entities, and non-transitory computer-readable medium described herein, the one or more messages may be communicated using the spatial resources that may be QCLed with the first resources for transmission of the SSB from the candidate cell based on the first control information.

Some examples of the method, network entities, and non-transitory computer-readable medium described herein may further include operations, features, means, or instructions for transmitting an RRC message that indicates the association between the TCI state and the first resources for transmission of the SSB, where the TCI state may be one of a set of TCI states included in the RRC message, each of the set of TCI states having corresponding sets of resources for transmission of one or more SSBs.

Some examples of the method, network entities, and non-transitory computer-readable medium described herein may further include operations, features, means, or instructions for receiving an RRC message indicating an additional association between the reference signal and the SSB, where the first control information may be transmitted via the RRC message, and where the association between the first resources and the TCI state may be based on the additional association between the reference signal and the SSB.

In some examples of the method, network entities, and non-transitory computer-readable medium described herein, the first resources for transmission of the SSB include a downlink frequency resource, an SSB SCS, a PCID, an SSB index, or any combination thereof.

In some examples of the method, network entities, and non-transitory computer-readable medium described herein, the first control information may be transmitted via an RRC message and the RRC message further indicates a TCI type associated with the TCI state for the candidate cell.

Some examples of the method, network entities, and non-transitory computer-readable medium described herein may further include operations, features, means, or instructions for transmitting a cell switch command indicating for the UE to switch from the serving cell to the candidate cell, where the cell switch command includes the first control information.

In some examples of the method, network entities, and non-transitory computer-readable medium described herein, the cell switch command includes a MAC-CE message.

In some examples of the method, network entities, and non-transitory computer-readable medium described herein, the cell switch command further includes an activation of the TCI state for the candidate cell.

Some examples of the method, network entities, and non-transitory computer-readable medium described herein may further include operations, features, means, or instructions for transmitting second control information that may be indicative of the TCI state and a downlink control channel order associated with a set of random access occasions, and where the set of random access occasions correspond to a set of SSBs including the SSB, receiving, based on transmitting the second control information, a of first random access message via a random access occasion of the set of random access occasions, where the random access occasion corresponds to the SSB, and transmitting a second random access message in response to the first random access message, where the second random access message includes the first control information that may be indicative of the association between the TCI state and first resources for transmission of the SSB.

Some examples of the method, network entities, and non-transitory computer-readable medium described herein may further include operations, features, means, or instructions for transmitting second control information indicating a set of TA values and corresponding sets of resources for transmission of SSBs, where the sets of resources include the first resources and transmitting a cell switch command including the indication of the TCI state and an indication of a TA value from the set of TA values, where the first control information may be based on the indicated TA value corresponding to the first resources for transmission of the SSB indicated via the second control information.

Some examples of the method, network entities, and non-transitory computer-readable medium described herein may further include operations, features, means, or instructions for transmitting, via the serving cell, an indication of a channel state information configuration for the reference signal of the candidate cell, where the first resources include a root QCL source associated with the reference signal, where the reference signal may be a CSI-RS.

In some examples of the method, network entities, and non-transitory computer-readable medium described herein, the one or more messages may be communicated using the SSB as the QCL source for the TCI state based on the first control information and the method, apparatuses, and non-transitory computer-readable medium may include further operations, features, means, or instructions for transmitting, via the candidate cell, a control message indicating the reference signal of the candidate cell and communicating one or more additional messages via the candidate cell using the reference signal as the QCL source based on transmitting the control message.

Some examples of the method, network entities, and non-transitory computer-readable medium described herein may further include operations, features, means, or instructions for transmitting, via the serving cell, a cell switch command indicating for the UE to switch from the serving cell to the candidate cell, where the one or more messages may be communicated using the SSB as the QCL source for the TCI state based on the first control information and the cell switch command, identifying an expiration of a timer based on receiving the cell switch command, and communicating one or more additional messages with the UE using the reference signal as the QCL source based on identifying the expiration of the timer.

Some examples of the method, network entities, and non-transitory computer-readable medium described herein may further include operations, features, means, or instructions for transmitting, via the serving cell, the candidate cell, or both, an indication of the timer, where identifying the expiration of the timer may be based on transmitting the indication of the timer.

In some examples of the method, network entities, and non-transitory computer-readable medium described herein, the indication of the TCI state and the first control information may be transmitted via a same control message.

In some examples of the method, network entities, and non-transitory computer-readable medium described herein, the QCL source indicates that the spatial resources used by the UE for communications with the candidate cell may be QCLed with a channel-state information reference signal of the candidate cell.

A method for wireless communications by a network entity is described. The method may include transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell and communicating one or more messages with the UE via the candidate cell using the spatial resources, where the spatial resources are based on the SSB.

A network entity for wireless communication is described. The network entity may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the network entity to transmit, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell and communicate one or more messages with the UE via the candidate cell using the spatial resources, where the spatial resources are based on the SSB.

Another network entity for wireless communications is described. The network entity may include means for transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell and means for communicating one or more messages with the UE via the candidate cell using the spatial resources, where the spatial resources are based on the SSB.

A non-transitory computer-readable medium storing code for wireless communications is described. The code may include instructions executable by a processor to transmit, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell and communicate one or more messages with the UE via the candidate cell using the spatial resources, where the spatial resources are based on the SSB.

Some examples of the method, network entities, and non-transitory computer-readable medium described herein may further include operations, features, means, or instructions for transmitting, from the serving cell, a cell switch command indicating for the UE to switch from the serving cell to the candidate cell, where communicating the one or more messages may be based on transmitting the cell switch command.

In some examples of the method, network entities, and non-transitory computer-readable medium described herein, the indication of the TCI state may be transmitted via the cell switch command.

Some examples of the method, network entities, and non-transitory computer-readable medium described herein may further include operations, features, means, or instructions for transmitting an RRC message indicating associations between a set of TCI states and sets of resources for receipt of SSBs, where the set of TCI states include the indicated TCI state, and where the sets of resources include first resources associated with the SSB, where transmitting the indication of the TCI state may be based on transmitting the RRC message.

### BRIEF DESCRIPTION OF THE DRAWINGS

FIG. 1 shows an example of a wireless communications system that supports techniques for transmission configuration indicator (TCI) association with candidate cell synchronization signal blocks (SSBs) in accordance with one or more aspects of the present disclosure.

FIG. 2 shows an example of a wireless communications system that supports techniques for TCI association with candidate cell SSBs in accordance with one or more aspects of the present disclosure.

FIG. 3 shows an example of a timeline for a cell switch procedure that supports techniques for TCI association with candidate cell SSBs in accordance with one or more aspects of the present disclosure.

FIG. 4 shows an example of a process flow that supports techniques for TCI association with candidate cell SSBs in accordance with one or more aspects of the present disclosure.

FIG. 5 shows an example of a process flow that supports techniques for TCI association with candidate cell SSBs in accordance with one or more aspects of the present disclosure.

FIGS. 6 and 7 show block diagrams of devices that support techniques for TCI association with candidate cell SSBs in accordance with one or more aspects of the present disclosure.

FIG. 8 shows a block diagram of a communications manager that supports techniques for TCI association with candidate cell SSBs in accordance with one or more aspects of the present disclosure.

FIG. 9 shows a diagram of a system including a device that supports techniques for TCI association with candidate cell SSBs in accordance with one or more aspects of the present disclosure.

FIGS. 10 and 11 show block diagrams of devices that support techniques for TCI association with candidate cell SSBs in accordance with one or more aspects of the present disclosure.

FIG. 12 shows a block diagram of a communications manager that supports techniques for TCI association with candidate cell SSBs in accordance with one or more aspects of the present disclosure.

FIG. 13 shows a diagram of a system including a device that supports techniques for TCI association with candidate cell SSBs in accordance with one or more aspects of the present disclosure.

FIGS. 14 through 17 show flowcharts illustrating methods that support techniques for TCI association with candidate cell SSBs in accordance with one or more aspects of the present disclosure.

### DETAILED DESCRIPTION

Wireless devices, such as user equipments (UEs), may switch between serving cells as the wireless devices move within a wireless network. UEs may be configured to perform measurements of reference signals from other cells (e.g., channel state information reference signals (CSI-RSs), synchronization signal blocks (SSBs)) in order to identify candidate cells for cell switch/handover procedures. When moving from a first cell (e.g., current, source cell) to a second cell (e.g., target, candidate cell), the first cell may indicate a transmission configuration indicator (TCI) state that the UE is to use for communicating with the second cell. Additionally, the first cell may indicate a reference signal (e.g., CSI-RS) that serves as a quasi co-location (QCL) source for communications performed using the indicated TCI state. That is, the UE may be configured with a CSI-RS configuration for a CSI-RS resource that is used to determine QCL properties for the TCI state.

However, in some cases, the first cell may only provide an SSB configuration for SSBs communicated by a candidate cell, and the UE may not receive and/or process a CSI-RS configuration for the candidate cell until the UE has performed a handover from the first cell to the second cell. That is, even if an activated TCI state indicates a CSI-RS as a QCL source, the UE may not receive/process the CSI-RS configuration for the CSI-RS as the QCL source until after the UE has fully switched to the second cell. As such, without the CSI-RS configuration, the UE may be unable to derive QCL properties for the TCI state that are used to receive signals from the second cell to evaluate a switch/handover to the second cell.

Accordingly, aspects of the present disclosure are directed to techniques that enable SSBs to serve as a QCL source for TCI states. In particular, aspects of the present disclosure are directed to signaling and configurations that enable UEs to derive QCL properties for a TCI state from an SSB even when the TCI state specifies a CSI-RS as its QCL source.

For example, when evaluating a switch from a first cell to a second cell, a UE may receive an indication of a TCI state for communicating with the second cell, where the TCI state indicates a CSI-RS as the QCL source for the TCI state. In this example, aspects of the present disclosure may provide some “linkage” between the TCI state and/or the CSI-RS and an SSB so that the UE can use the linked SSB as the QCL source for the TCI state. For instance, an RRC message may indicate a TCI state list with corresponding CSI-RSs and SSBs for each respective TCI state. As such, the UE may use some linkage information to derive the appliable SSB of the second cell, where the identified SSB is used as the QCL source for the activated TCI state. After switching from the first cell to the second cell, the UE may determine when to revert back to using the applicable CSI-RS as the QCL source, such as based on explicit signaling from the network and/or based on an expiration of a timer.

In additional or alternative implementations, TCI states activated by a network may directly indicate that SSBs are to be used as the QCL source. That is, instead of TCI states pointing to CSI-RSs as QCL sources, networks may instead configure TCI states to point directly to SSBs as the QCL source for the TCI states.

Aspects of the disclosure are initially described in the context of wireless communications systems. Additional aspects of the disclosure are described in the context of an example cell switch procedure and example process flows. Aspects of the disclosure are further illustrated by and described with reference to apparatus diagrams, system diagrams, and flowcharts that relate to techniques for TCI association with candidate cell SSBs.

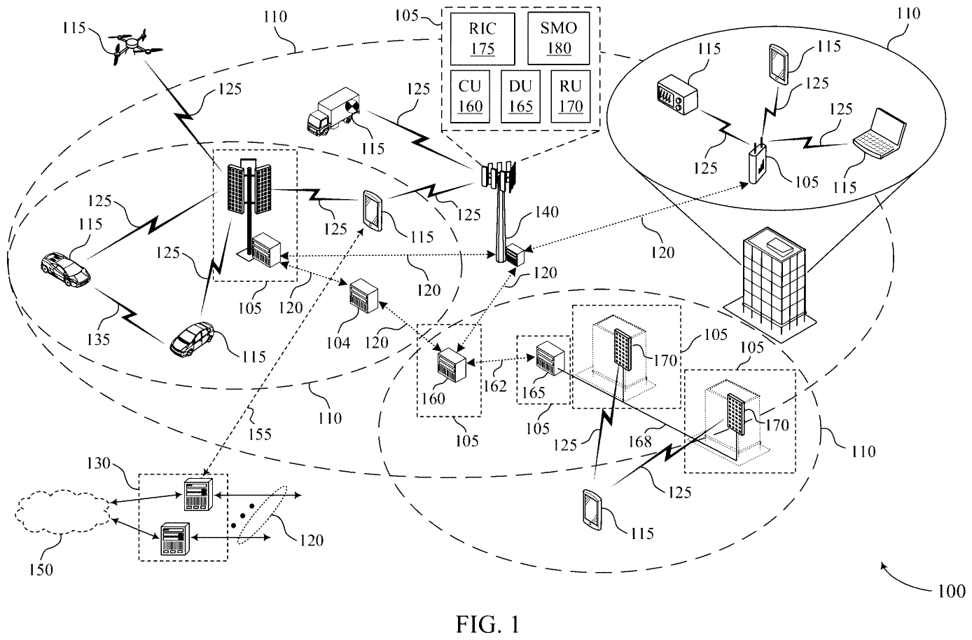

FIG. 1 shows an example of a wireless communications system 100 that supports techniques for TCI association with candidate cell SSBs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for TCI association with candidate cell SSBs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing (SCS) may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UEs 115 and the network entities 105 of the wireless communications system 100 may be configured to support techniques that enable SSBs to serve as a QCL source for TCI states. In particular, the devices of the wireless communications system 100 may support signaling and configurations that enable UEs 115 to derive QCL properties for a TCI state from an SSB even when the TCI state specifies a CSI-RS as its QCL source.

For example, when evaluating a switch from a first cell to a second cell (e.g., cells supported by network entities 105 of the wireless communications system 100), a UE 115 may receive an indication of a TCI state for communicating with the second cell, where the TCI state indicates a CSI-RS as the QCL source for the TCI state. In this example, aspects of the present disclosure may provide some “linkage” between the TCI state and/or the CSI-RS and an SSB so that the UE 115 can use the linked SSB as the QCL source for the TCI state. For instance, an RRC message may indicate a TCI state list with corresponding CSI-RSs and SSBs for each respective TCI state. As such, the UE may use some linkage information to derive the appliable SSB of the second cell, where the identified SSB is used as the QCL source for the activated TCI state. After switching from the first cell to the second cell, the UE may determine when to revert back to using the applicable CSI-RS as the QCL source, such as based on explicit signaling from the network and/or based on an expiration of a timer.

Techniques described herein may enable SSBs of candidate cells to serve as a QCL source for TCI states activated for the candidate cells. As such, techniques described herein may facilitate cell switch/handover procedures performed by UEs 115 by enabling the UEs 115 to derive QCL properties for TCI states based on SSBs of the candidate cells. In particular, in cases where CSI-RS configurations for a candidate cell are not received and/or processed at the UE 115 until after a cell handover to the candidate cell has been completed, techniques described herein may enable the UE 115 to derive QCL properties of the TCI state for the candidate cell using SSBs of the candidate cell, thereby enabling the UE 115 to derive QCL properties prior to performing and/or completing the cell handover to the candidate cell.

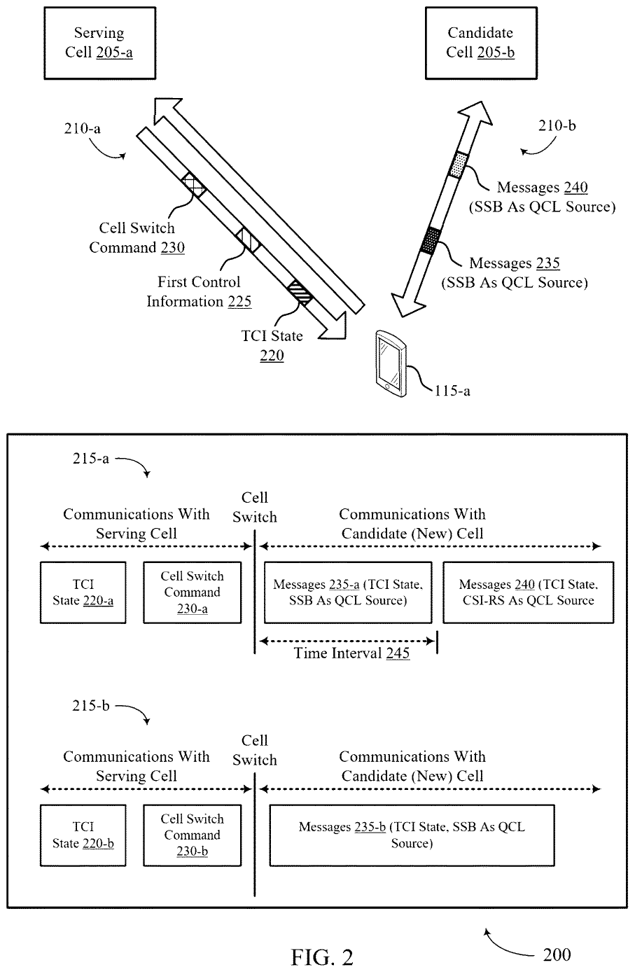

FIG. 2 shows an example of a wireless communications system 200 that supports techniques for TCI association with candidate cell SSBs in accordance with one or more aspects of the present disclosure. Aspects of the wireless communications system 200 may implement, or be implemented by, aspects of the wireless communications system 100. For example, the wireless communications system 200 may support signaling and configurations that enable a UE 115-a to use SSBs of a candidate cell 205-b as a QCL source for a TCI state activated for the candidate cell 205-b, as described previously herein.

The wireless communications system 200 may include a UE 115-a, a serving cell 205-a, and a candidate cell 205-b (e.g., target cell), which may be examples of UEs 115, network entities 105, and other wireless devices as described with reference to FIG. 1. In some cases, the serving cells 205 may be associated with (e.g., supported by) one or more network entities 105. For example, in some cases, the serving cell 205-a and the candidate cell 205-b may be associated with (e.g., supported by) the same network entity 105. By way of another example, in other cases, the serving cell 205-a may be associated with a first network entity 105, and the candidate cell 205-b may be associated with a second network entity 105. The cells 205 may be associated with the same or different radio access technologies (RATs) (e.g., 3G, 4G, LTE, 5G, NR, 6G, etc.), and may be configured to communicate within the same or different frequency bands.

In some aspects, the UE 115-a may communicate with the cells 205 via communication links 210-a, 210-b. In some cases, the communication links 210 may include examples of access links (e.g., Uu links). The communication link 210 may include bi-directional links that can include both uplink and downlink communication. For example, the UE 115-a may transmit uplink transmissions, such as uplink control signals or uplink data signals, to the serving cell 205-a using the communication link 210-a, and the serving cell 205-a may transmit downlink transmissions, such as downlink control signals or downlink data signals, to the UE 115-a using the communication link 210-a.

Some wireless communications systems (e.g., wireless communications system 100) include multiple network entities 105 that provide communication resources (e.g., serving cells 205) to a UEs 115 and other wireless devices. In some approaches, handover (or switching between serving cells 205) may be performed using Layer 3 (L3) signaling. However, using L3 signaling for handover may result in relatively high handover latency. Alternatively, UEs 115 may use Layer 1 (L1) or Layer 2 (L2) signaling to switch between cells 205 to reduce latency. To switch from a source serving cell 205 (e.g., serving cell 205-a) to a candidate cell 205 (e.g., candidate cell 205-b), the UE 115 may utilize a beam associated with the candidate cell 205-b. The beam to be used may be indicated by a TCI state in the form of a QCLed source reference signal (e.g., CSI-RS).

One or more lower-layer triggered mobility (LTM) mechanisms or procedures may be utilized for mobility latency reduction. For example, configuration and maintenance for multiple candidate cells 205 may allow for application of configurations for candidate cells 205. A dynamic switch mechanism may be utilized among candidate serving cells (including special cells (SpCell) and secondary cells (SCells), for example) for scenarios based on L1 or L2 signaling. For instance, an SpCell may be updated via L1 or L2 signaling based on an L1 measurement. L1 enhancements may be utilized for inter-cell beam management, including L1 measurement and reporting, and beam indication. In some examples, timing advance (TA) management may be utilized. CU-DU interface signaling may be utilized to support L1 or L2 mobility. Frequency range 2 (FR2) specific enhancements may be utilized in some approaches.

In some examples, procedures for L1 or L2-based inter-cell mobility may be applicable to one or more of the following scenarios: (1) standalone, carrier aggregation (CA), or new radio dual connectivity (NR-DC) cases (with a serving cell change within one cell group (CG), for example); (2) an intra-DU case and intra-CU inter-DU case (which may be applicable for standalone and CA cases with no new radio access network (RAN) interfaces, for example); (3) intra-frequency or inter-frequency cases; (4) Frequency range 1 (FR1) or FR2 cases; or (5) cases where source and target cells may be synchronized or non-synchronized.

As described previously herein, the UE 115-a may switch between serving cells 205 as the UE 115-a moves within a wireless network. The UE 115-a may be configured to perform measurements of reference signals (e.g., CSI-RSs, SSBs) from other candidate cells 205 (e.g., candidate cell 205-b) in order to identify candidate cells 205 for cell switch/handover procedures. When moving from the serving cell 205-a to the candidate cell 205-b, the serving cell 205-a may indicate a TCI state that the UE 115-a is to use for communicating with the candidate cell 205-b. Additionally, the serving cell 205-a may indicate a reference signal (e.g., CSI-RS) that serves as a QCL source for communications performed using the indicated TCI state. That is, the UE 115-a may be configured with a CSI-RS configuration for a CSI-RS resource that is used to determine QCL properties for the TCI state.

In the context of L1/L2 mobility (e.g., mobility of the UE 115-a between the serving cell 205-a and the candidate cell 205-b), there are several different options for indicating TCI state activations of the candidate cell 205-b. In accordance with a first implementation, the UE 115-a may receive the TCI state activation of the candidate cell 205-b before the reception of the beam indication of the candidate cell 205-b. In accordance with a second implementation, the UE 115-a may receive the TCI state activation of the candidate cell 205-b together with the reception of the beam indication of the candidate cell 205-b. In some cases, UEs 115 may be configured to support the first implementation, the second implementation, or both, based on the capabilities of the respective UE 115.

However, in some cases, the serving cell 205-a may only provide an SSB configuration for SSBs communicated by the candidate cell 205-b, and the UE 115-a may not receive and/or process a CSI-RS configuration for the candidate cell 205-b until the UE 115-a has performed a handover from the serving cell 205-a to the candidate cell 205-b. That is, even if an activated TCI state indicates a CSI-RS as a QCL source, the UE 115-a may not receive/process the CSI-RS configuration for the CSI-RS as the QCL source until after the UE 115-a has fully switched to the candidate cell 205-b. As such, without the CSI-RS configuration, the UE 115-a may be unable to derive QCL properties for the TCI state that are used to receive signals from the candidate cell 205-b to evaluate a switch/handover to the candidate cell 205-b.

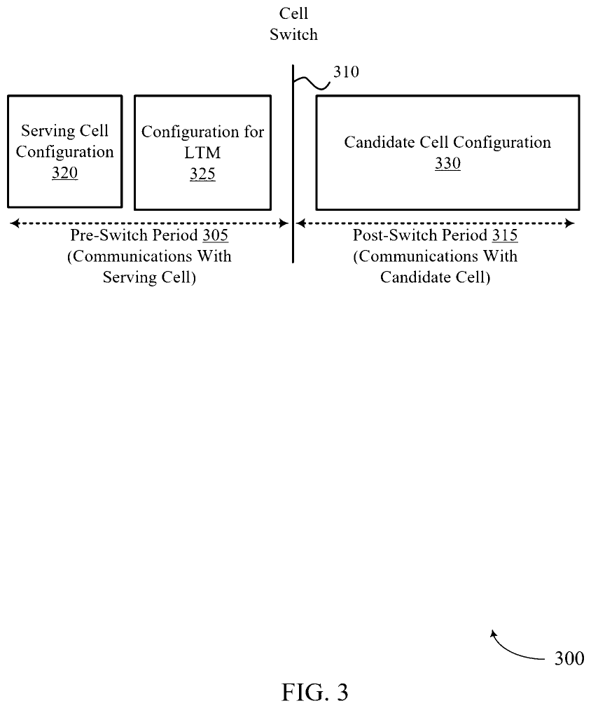

This may be further shown and described with reference to FIG. 3.

FIG. 3 shows an example of a timeline 300 for a cell switch procedure that supports techniques for TCI association with candidate cell SSBs in accordance with one or more aspects of the present disclosure. Aspects of the timeline 300 may implement, or be implemented by, aspects of the wireless communications system 100, the wireless communications system 200, or both.

In particular, the timeline 300 illustrates a cell switch procedure performed by the UE 115-a to switch from the serving cell 205-a to the candidate cell 205-b illustrated in FIG. 2. In this example, the timeline 300 includes a pre-switch period 305, a cell switch 310, and a post-switch period 315. In some aspects, the UE 115-a may be configured to communicate with the serving cell 205-a during the pre-switch period 305, and may be configured to communicate with the candidate cell 205-b during the post-switch period 315 after performing the cell switch 310 (e.g., cell handover).

During the pre-switch period 305, the UE 115-a may receive a serving cell configuration 320 from the serving cell 205-a. The serving cell configuration 320 may include information usable by the UE 115-a for communicating with the serving cell 205-a, such as TCI states, reference signals, indications of resources (e.g., BWPs) for communicating with the serving cell 205-a, and the like. In some cases, during the pre-switch period 305, the UE 115-a may additionally receive a TCI activation command for activating a TCI state for the candidate cell 205-b, as well as a cell switch command (e.g., TCI indication) for performing the cell switch 310 from the serving cell 205-a to the candidate cell 205-b. In some implementations, the UE 115-a may receive the TCI activation and indication before (or together) with cell switch command instructing the UE 115-a to perform the cell switch 310.

In some cases, before performing the cell switch 310 (e.g., cell handover), the UE 115-a may receive (e.g., from the serving cell 205-a) a configuration for LTM 325, where the configuration for LTM 325 provides the UE 115-a with limited information regarding the candidate cell 205-b. For instance, the configuration for LTM 325 may provide some limited TCI state or reference signal information corresponding to the candidate cell 205-b (where the UE 115-a then performs communications with the candidate cell 205-b using the indicated TCI state following the cell switch 310). In some cases, the configuration for LTM 325 may include or indicate SSB resources used by the UE 115-a for performing L1 measurements for the candidate cell 205-b.

In some cases, each TCI state for the candidate cell 205-b may include up to two QCL-types, where each QCL-type source reference signal of a QCL-info of the TCI state is provided based on the configuration for LTM 325. Stated differently, a TCI state activated for the candidate cell 205-b may be associated with a reference signal of the candidate cell 205-b that serves as the QCL source for deriving QCL properties for the TCI state. In some wireless networks, a TCI state that can be used by the UE 115-a for receiving PDCCH/PDSCH messages points to a CSI-RS resources that is used as the QCL source reference signal. In other words, in some wireless networks, each TCI state is associated with a CSI-RS resource that serves as the QCL source (e.g., is used to derive QCL properties) for the TCI state. The CSI-RS resources may be indicated or defined in a candidate cell configuration 330. For example, as shown in FIG. 3, the UE 115-a may receive a candidate cell configuration 330 that includes information for communicating with the candidate cell 205-b (e.g., CSI-RS resources, beams, etc.).

However, in some cases, the candidate cell configuration 330 may not be received (and/or processed) by the UE 115-b until after the cell switch 310. In such cases, because the candidate cell configuration 330 (which includes the CSI-RS configuration) is not received and/or processed by the UE 115-a until after the cell switch 310, the UE 115-a may not be able to derive QCL properties for the TCI state activated for the candidate cell 205-b (based on the CSI-RS configuration) until after the cell switch 310 has been completed. The inability to determine the CSI-RS configuration (which is used as the QCL source for the activated TCI state) until after the cell switch 310 may delay the cell switch 310 (e.g., increased cell switch latency), and/or delay the ability of the UE 115-a to communicate with the candidate cell 205-b following the cell switch 310.

Accordingly, aspects of the present disclosure are directed to techniques that enable SSBs to serve as a QCL source for TCI states. In particular, aspects of the present disclosure are directed to signaling and configurations that enable UEs 115 to derive QCL properties for a TCI state from an SSB even when the TCI state specifies a CSI-RS as its QCL source. In particular, since SSB resources for the candidate cell 205-b are configured via the configuration for LTM 325 prior to the cell switch 310 (as compared to the CSI-RS configuration that is received/processed after the cell switch 310), aspects of the present disclosure that enable SSBs to serve as the QCL source for activated TCI states may enable the UE 115-a to derive QCL properties for the activated TCI state (using the SSBs as the QCL source) prior to the cell switch 310, which may reduce the latency of the cell switch 310 and may expedite the ability of the UE 115-a to communicate with the candidate cell 205-b following the cell switch 310.

Reference will again be made to FIG. 2. As described previously herein, for beam indication in LTM, when the UE 115-a is indicated or activated with a TCI state which contains CSI-RS as the QCL RS (e.g., CSI-RS as the QCL source), and when the CSI-RS configuration is not provided in a dedicated information element for LTM (as described with reference to FIG. 3), aspects of the present disclosure are directed to configurations and signaling that provide a linkage between a candidate cell 205-b SSB and a TCI state with CSI-RS as QCL RS, so that the QCL properties may for the TCI state may be derived using the SSB as the QCL source.

For example, as shown in FIG. 2, the UE 115-b may be in wireless communication with the serving cell 205-a, and may receive an indication of a TCI state 220 that is to be used for communications with the candidate cell 205-b. As described previously herein, the TCI state 220 may be associated with a QCL source that indicates that spatial resources are used by the UE 115-a for communications with the candidate cell 205-b are QCLed with a reference signal (e.g., CSI-RS) of the candidate cell 205-b. In other words, the TCI state 220 may be associated with a CSI-RS that is typically used as the QCL source for the TCI state 220. However, as described previously herein, the CSI-RS configuration may not be received and/or processed until after the UE 115-a completes a handover to the candidate cell 205-b, thereby delaying when the UE 115-a is able to derive QCL properties for the TCI state 220.

As such, in some aspects, the UE 115-a may receive first control information 225 that indicates an association between the TCI state 220 and a corresponding SSB resource(s) of the candidate cell 205-b. The first control information 225 that indicates associations between TCI state(s) 220 and corresponding SSB(s) may be indicated in accordance with multiple implementations.

In accordance with a first implementation, the first control information 225 that indicates the association between the TCI state 220 and the SSB resources of the candidate cell 205-b may be indicated via the indication of the TCI state 220 or corresponding RRC configuration (e.g., RRC signaling), which may be signaled separately from (e.g., outside of) the configurations for the serving cell 205-a and the candidate cell 205-b (e.g., the first control information 225 may be signaled separately from the serving cell configuration 320 and the candidate cell configuration 330).

For example, an RRC message may indicate a TCI state list that indicates TCI states, CSI-RS resources corresponding to the respective TCI states, and/or SSB resources corresponding to the respective TCI states. That is, the configuration of the TCI state list may include the TCI states and associations with SSB resources (e.g., SSB downlink carrier frequency, SSB SCS, PCID, SSB index), if the configuration of NZP-CSI-RS resource in the corresponding TCI state is not provided. Moreover, in some aspects, the configuration of the TCI state list (indicated via RRC signaling) may indicate a unified TCI state type (e.g., joint, separate downlink/uplink type) for each TCI and/or for each PCID. That is, RRC signaling (and/or other control signaling) may indicate a TCI state list including TCI states for the candidate cell 205-b, as well as a TCI type of each respective TCI state.

In accordance with a second implementation, the first control information 225 that indicates the association between the TCI state 220 and the SSB resources of the candidate cell 205-b may be indicated in a MAC-CE, such as via cell switching command MAC-CE or TCI activation MAC-CE. For example, in some cases, the TCI state 220 may be indicated via a TCI activation MAC-CE, where the TCI activation MAC-CE indicates which SSB resource is to be used for the TCI state 220.

In accordance with a third implementation, the first control information 225 that indicates the association between the TCI state 220 and the SSB resources of the candidate cell 205-b may be indicated as part of a PDCCH order, where a TCI ID can be signaled in the DCI or RACH message, and the indicated SSB is the linked one. That is, RRC signaling (or other control signaling) may indicate a set of TCI states and a downlink control channel order (e.g., PDCCH order) associated with a set of random access occasions (e.g., RACH occasions). In this example, the set of RACH occasions may correspond to SSBs of the candidate cell 205-b such that exchanges of RACH messages associated with the TCI state 220 may be used to indicate a corresponding SSB that is associated with the TCI state 220.

For instance, the UE 115-a may transmit RACH messages (e.g., Msg1) to the serving cell 205-a via a set of RACH occasions, where the respective RACH occasions are associated with corresponding SSB resources of the candidate cell 205-b in accordance with the configured PDCCH order. In this example, the serving cell 205-a may indicate which SSB is to be used as the QCL source (e.g., indicate the first control information 225 that indicates the association between the TCI state 220 and the SSB resources of the candidate cell 205-b) by transmitting a RACH message (e.g., Msg2) in response to the RACH message communicated by the UE 115-a via the RACH occasion corresponding to the selected SSB resource. For example, the TCI state 220 may be associated with a previously transmitted SSB resource of the candidate cell 205-b in a PRACH procedure.

In accordance with a fourth implementation, the first control information 225 that indicates the association between the TCI state 220 and the SSB resources of the candidate cell 205-b may be indicated based on the SSB being associated with an indicated TA value. For example, RRC signaling from the serving cell 205-a (and/or other control signaling) may indicate or include second control information indicating a set of TA values and corresponding sets of resources for receipt of SSBs. In other words, the RRC signaling may associate TA values with corresponding SSB resources such that indications of TA values may be used to indicate SSB resources that are to be used as a QCL source for an activated TCI state 220. In this example, the indication of the TCI state 220 and/or a cell switch command 230 may also indicate a TA value, thereby indicating the SSB that is to be used as the QCL source. For instance, the UE 115-a may receive a cell switch command 230 that indicates the TCI state 220 and a TA indication for the candidate cell 205-b, where the TCI state 220 may be associated with the SSB used for the indicated TA value.

In some implementations, when the CSI-RS configuration for the CSI-RS corresponding to the indicated TCI state 220 is provided in a dedicated information element for LTM, the UE 115-a may be configured to apply the SSB resource which is the root QCL source for the CSI-RS for deriving QCL properties. in other words, the UE 115-a may apply the SSB resource which is the root QCL source for the CSI-RS as the QCL source for the TCI state 220 when communicating with the candidate cell 205-b.

The UE 115-a may receive a cell switch command 230 that instructs the UE 115-a to switch from the serving cell 205-a to the candidate cell 205-b. As described previously herein, the cell switch command 230 may include or indicate the TCI state 220. Moreover, as described with reference to the various implementations above, the first control information 225 that indicates the association between the TCI state 220 and the SSB resources of the candidate cell 205-b may be communicated via a MAC-CE (e.g., MAC-CE indicating the TCI state 220), RRC signaling, other control signaling, the cell switch command 230, or any combination thereof.

Subsequently, upon performing a cell switch from the serving cell 205-a to the candidate cell 205-b, the UE 115-a may be configured to communicate messages 235 (e.g., PDCCH messages, PDSCH messages, PUCCH messages, PUSCH messages) with the candidate cell 205-b using spatial resources that are based on the association between the indicated TCI state 220 and the SSB resources of the candidate cell 205-b. In other words, the UE 115-a may communicate PUSCH/PUCCH/PDSCH/PDCCH messages 235 with the candidate cell 205-b in accordance with the indicated/activated TCI state 220, where the TCI state 220 is QCLed with the SSB resource(s) of the candidate cell 205-b (e.g., the SSB resource(s) serve as the QCL source for the TCI state 220).

In some cases, the UE 115-a and the candidate cell 205-b may be configured to revert back to using the CSI-RS (or other reference signal) of the candidate cell 205-b as the QCL source for the TCI state 220. For example, referring to the first cell switch configuration 215-a illustrated in FIG. 2, the UE 115-a may receive an indication of a TCI state 220-a, receive a cell switch command 230-a, and may communicate messages 235-a with the candidate cell 205-b using the indicated TCI state 220-a and the SSB resources of the candidate cell 205-b as the QCL source. Subsequently, the UE 115-a may return to using the CSI-RS as the QCL source for the TCI state 220-a, and may therefore perform messages 240 using the indicated TCI state 220-a and the applicable CSI-RS resources of the candidate cell 205-b as the QCL source.

The timing of the switch to using the CSI-RS as the QCL state for the TCI state 220-a (e.g., the timing of the switch between messages 235-a using SSB and messages 240 using CSI-RS) may be explicitly indicated by the candidate cell 205-b, implicitly determined (e.g., based on an expiration of some timer or timer interval), or both. For example, in some cases, the UE 115-a may receive an explicit indicator for using SSB or CSI-RS associated with the activated TCI state 220-a for deriving QCL properties after the cell switch command 230-a. In other words, the UE 115-a may use the SSB for deriving QCL properties until the candidate cell 205-b transmits an explicit indicator (e.g., control message) for using CSI-RS for deriving QCL properties.

By way of another example, the devices may be configured to implicitly switch between using SSBs or CSI-RSs for deriving QCL properties. For example, the UE 115-a may be configured to use the SSB for deriving QCL properties (e.g., as the QCL source) for some time interval 245 before the configuration of the candidate cell 205-b (e.g., candidate cell configuration 330) has been processed (e.g., within an application time or RRC processing time after the cell switch command 230-a). By way of another example, the UE 115-a may switch to using the CSI-RS as the QCL source after the candidate cell configuration has been processed (e.g., after an application time since the cell switch command). In these examples, the time interval 245 that the UE 115-a continues to use the SSB to derive QCL properties may be based on the application time, based on a timer (which may be configured via RRC signaling and/or the cell switch command 230-a), and the like. As such, the duration of the time interval 245 (e.g., timer) may be predetermined/configured (e.g., known by both the UE 115-a and the network, such as based on RRC processing time for the candidate cell 205-b), or up to UE 115-a implementation.

The previous examples described herein describe cases where TCI states 220 are typically associated with a reference signal (e.g., CSI-RS) as the QCL source, but where an SSB may temporarily serve as the QCL source. However, in other cases, SSBs may (e.g., permanently) serve as the QCL source for TCI states 220, rather than using CSI-RSs as is done in some conventional networks.

For example, in alternative implementations, for beam indication in LTM, the UE 115-a may be indicated or activated with a TCI state 220 which contains an SSB resource of the candidate cell 205-b as the QCL RS, where the UE 115-a may be configured to apply the indicated TCI state 220 using the respective SSB resource as the QCL source for all the channels/reference signals after switching from the serving cell 205-a to the candidate cell 205-b. As such, messages communicated via all dedicated and non-dedicated PDCCH, PDSCH, PUCCH, and PUSCH may be communicated according to the indicated/activated TCI state 220, with QCL properties derived based on the SSB of the candidate cell 205-b.

For instance, referring to the second cell switch configuration 215-b in FIG. 2, the UE 115-b may receive an indication of a TCI state 220-b for communicating with the candidate cell 205-b, wherein the TCI state 220-b is associated with a QCL source that indicates that spatial resources used by the UE 115-a for communications with the candidate cell 205-b are QCLed with an SSB of the candidate cell 205-b. In some cases, as described previously herein, RRC signaling (and/or other control signaling) may configure the UE 115-a with a TCI list that includes TCI states 220 and SSB resources that correspond to the respective TCI states 220.

Continuing with reference to the second cell switch configuration 215-b, the UE 115-a may additionally receive a cell switch command 230-b instructing the UE 115-a to switch from the serving cell 205-a to the candidate cell 205-b. As described previously herein, the indication of the TCI state 220-b and the cell switch command 230-b may be received via a same control message (e.g., MAC-CE). Subsequently, the UE 115-a may perform a cell switch/handover to the candidate cell 205-b, and may communicate messages 235-b with the candidate cell 205-b using the indicated TCI state 220-b and the SSB resource(s) of the candidate cell 205-b as the QCL source. That is, the UE 115-a may communicate the messages 235-b with the candidate cell 205-b using spatial resources that are based on measurements of the SSB resource(s) from the candidate cell 205-b. As compared to the first cell switch configuration 215-a where the UE 115-a returns to using the CSI-RS as the QCL source for the TCI state 220-a based on an implicit or explicit indication, in the second cell switch configuration 215-b, the TCI states 220 may be (permanently) associated with SSBs as the QCL source, thereby negating the need to switch back to using CSI-RSs.

Techniques described herein may enable SSBs of the candidate cell 205-b to serve as a QCL source for TCI states 220 activated for the candidate cell 205-b. As such, techniques described herein may facilitate cell switch/handover procedures performed by the UE 115-a by enabling the UE 115-a to derive QCL properties for TCI states 220 based on SSBs of the candidate cell 205-b. In particular, in cases where CSI-RS configurations for a candidate cell 205-b are not received and/or processed at the UE 115-a until after a cell handover to the candidate cell 205-b has been completed, techniques described herein may enable the UE 115-a to derive QCL properties of the TCI state 220 for the candidate cell 205-b using SSBs of the candidate cell 205-b, thereby enabling the UE 115-a to derive QCL properties prior to performing and/or completing the cell handover to the candidate cell 205-b.

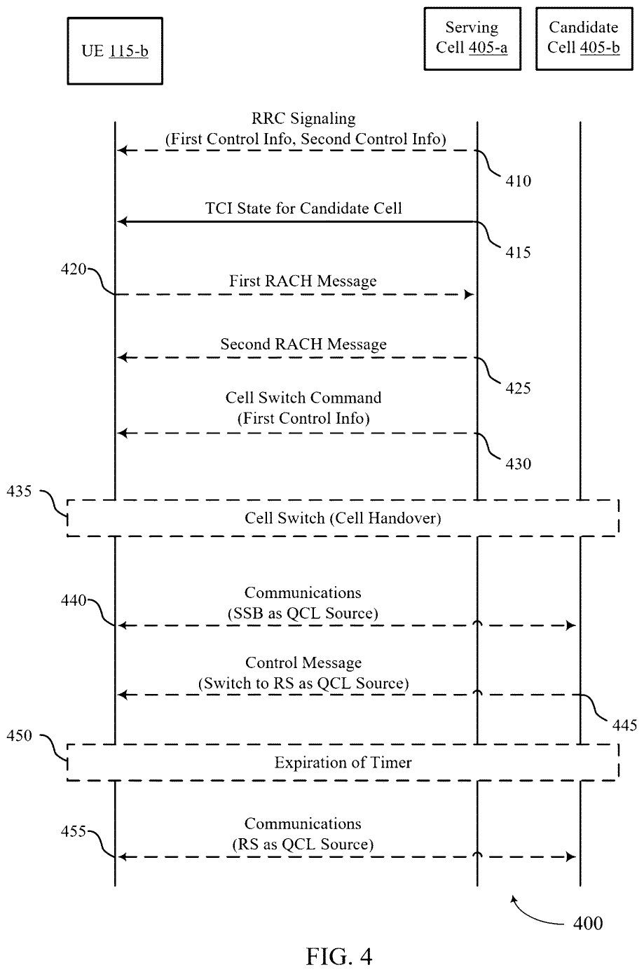

FIG. 4 shows an example of a process flow 400 that supports techniques for TCI association with candidate cell SSBs in accordance with one or more aspects of the present disclosure. Aspects of the process flow 400 may implement, or be implemented by, aspects of the wireless communications system 100, the wireless communications system 200, the timeline 300, or any combination thereof. For example, the process flow 400 illustrates signaling and configurations that enable a UE 115-b to use SSBs of a candidate cell as a QCL source for a TCI state activated for the candidate cell, as described previously herein.

The process flow 400 includes a UE 115-b, a serving cell 405-a, and a candidate cell 405-b, which may be examples of UEs 115, network entities 105, serving cells 205, and other wireless devices as described herein. For example, the UE 115-b, the serving cell 405-a, and the candidate cell 405-b illustrated in FIG. 4 may include examples of the UE 115-a, the serving cell 205-a, and the candidate cell 205-b, respectively, as illustrated in FIG. 2. In this regard, the serving cell 405-a and the candidate cell 405-b may be associated with (e.g., supported by) the same or different network entities 105, and may be configured to communicate using the same or different frequency bands/RATs.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 410, the UE 115-b may receive RRC signaling (and/or other control signaling) from the serving cell 405-a. In some aspects, the RRC signaling may include first control information that indicates associations between TCI states and sets of resources for receiving SSBs (e.g., resources for receiving SSBs from the candidate cell 405-b). In other words, the RRC message may indicate a TCI state list, and SSB resources that correspond to the respective TCI states within the TCI state list. Additionally, or alternatively, RRC message may indicate associations between SSB resources of the candidate cell 405-b and resources for additional reference signals (e.g., CSI-RSs) of the candidate cell 405-b. For example, the RRC message may indicate a list of SSB resources and corresponding CSI-RS resources of the candidate cell 405-b.

In some aspects, the RRC signaling (and/or other control signaling) may indicate other information that enables the UE 115-b to use SSBs of the candidate cell 405-b as a QCL source for activated TCI states. For example, in some cases, the RRC signaling (and/or other control signaling) may include second control information that is indicative of TCI states and a downlink control channel order (e.g., PDCCH order) associated with a set of random access occasions (e.g., RACH occasions). In this example, the set of RACH occasions may correspond to SSBs of the candidate cell such that exchanges of RACH messages associated with a TCI state may be used to indicate a corresponding SSB that is associated with the TCI state. The use of PDCCH order/RACH messages to indicate associations between TCI states and SSB resources will be further described herein.

By way of another example, in additional or alternative implementations, the RRC signaling (and/or other control signaling) may indicate or include second control information indicating a set of TA values and corresponding sets of resources for receipt of SSBs. In other words, the RRC signaling may associate TA values with corresponding SSB resources such that indications of TA values may be used to indicate SSB resources that are to be used as a QCL source for an activated TCI state.

In additional or alternative implementations, the RRC signaling may include an indication of a CSI-RS configuration for CSI-RSs of the candidate cell 405-b. In such cases, the UE 115-b may be configured to use SSB resources that include a root QCL source associated with the CSI-RS associated with the CSI-RS configuration. Moreover, in some cases, the RRC signaling may indicate TCI types for TCI states associated with the candidate cell 405-b.

At 415, the UE 115-b may receive, from the serving cell 405-a, an indication of a TCI state for communicating with the candidate cell 405-b. In some aspects, the TCI state is associated with a QCL source that indicates that spatial resources used by the UE 115-b for communications with the candidate cell 405-b are QCLed with a reference signal (e.g., CSI-RS) of the candidate cell 405-b. In other words, the indication/activation of the TCI state may indicate a CSI-RS resource of the candidate cell 405-b that is to be used as the QCL source for the activated TCI state when communicating with the candidate cell 405-b.

In some cases, the applicable reference signal(s) (e.g., CSI-RS) that serves as the QCL source for the indicated TCI state may be defined via the TCI state list indicated via the RRC signaling at 410. Additionally, or alternatively, the message at 415 indicating/activating the TCI state may also indicate which CSI-RS of the candidate cell 405-b is to be used as the QCL source for the TCI state. In other words, in some cases, the indication of the TCI state at 415 and the first control information that indicates the association between the TCI state and the SSB resource of the candidate cell 405-b may be received via a same control message.

In some cases, the UE 115-b may identify the SSB resource that corresponds TCI state based on the CSI-RS for the respective TCI state. For example, in cases where the RRC signaling includes a table or other data object that indicates associations between SSB resources and CSI-RS resources, the UE 115-b may determine the CSI-RS associated with the TCI state, and may reference the table/data object using the identified CSI-RS to determine the corresponding SSB resource that is to be used as the QCL source for the TCI state.

At 420, the UE 115-b may transmit a first random access message (e.g., first RACH message) to the serving cell 405-a. The UE 115-b may transmit the first random access message at 420 based on receiving the RRC signaling at 410, receiving the indication/activation of the TCI state at 415, or both.

In particular, the UE 115-b may transmit the first random access message in accordance with a PDCCH order indicated via the second control message included within the RRC signaling at 410. For example, the UE 115-b may transmit a set of RACH messages (e.g., Msg1) via a set of RACH occasions in accordance with a PDCCH order indicated via the RRC signaling, where the respective RACH occasions correspond to respective sets of SSB resources associated with the candidate cell 405-b (as defined by the second control information).

At 425, the UE 115-b may receive a second random access message (e.g., second RACH message) from the serving cell 405-a. The UE 115-b may receive the second random access message at 425 based on receiving the RRC signaling at 410, receiving the indication/activation of the TCI state at 415, transmitting the first random access message at 420, or any combination thereof.

For example, the serving cell 405-a may transmit a second RACH message (e.g., Msg2) in response to one of the RACH messages transmitted at 420. In particular, the serving cell 405-a may transmit the second RACH message responsive to the first RACH message that was received via the RACH occasion that corresponds to the SSB resource of the candidate cell 405-b. In this regard, the serving cell 405-a may indicate which SSB resource of the candidate cell 405-b is to be used as the QCL source for the indicated/activated TCI state by transmitting the second RACH message responsive to the first RACH message that was communicated via the RACH occasion corresponding to the respective SSB resource. In such examples, the communication of the second RACH message may be regarded as the “first control information” that indicates the association between the indicated TCI state and the corresponding SSB resource.

At 430, the UE 115-b may receive a cell switch command from the serving cell 405-a, where the cell switch command indicates for the UE 115-b to switch from serving cell 405-a to the candidate cell 405-b. The cell switch command may be communicated via a MAC-CE. In some aspects, the UE 115-c may receive the cell switch command based on receiving the RRC signaling at 410, receiving the indication/activation of the TCI state at 415, transmitting/receiving the RACH messages at 420 and 425, or any combination thereof.

Additionally, or alternatively, the indication of the TCI state and the cell switch command may be received via the same message (e.g., the cell switch command at 430 may indicate/activate the TCI state shown at 415). Moreover, in some aspects, the cell switch command may include an activation of the TCI state for the candidate cell 405-b that was indicated at 415.

Further, in some cases, the cell switch command at 430 may include the first control information that indicates the association between the indicated TCI state and the SSB resource of the candidate cell 405-b. For example, in some cases, the cell switch command may indicate a TA value from the set of TA values that was configured via the RRC signaling at 410. In this example, the indicated TA value may correspond to the SSB resource that is to be used as the QCL source for the indicated TCI state. That is, the RRC signaling may define associations between TA values and SSB resources, where the cell switch command may indicate which TA value (and therefore which SSB resource) is to be used.

At 435, the UE 115-c may perform the cell switch (e.g., cell handover) from the serving cell 405-a to the candidate cell 405-b. In some cases, performance of the cell switch/handover may include additional signaling between the UE 115-b and the respective cells, additional signaling between the serving cell 405-a and the candidate cell 405-b, or both.

At 440, the UE 115-b may perform communications with the candidate cell 405-b using the spatial resources for the TCI state, where the spatial resources are based on the association between the SSB resources and the TCI state. In other words, the UE 115-b may communicate PUSCH/PUCCH/PDSCH/PDCCH messages with the candidate cell 405-b in accordance with the TCI state that was indicated/activated at 415, where the TCI state is QCLed with the SSB resource(s) of the candidate cell 405-b (e.g., the SSB resource(s) serve as the QCL source for the TCI state).

Stated differently, the UE 115-b may communicate messages with the candidate cell 405-b in accordance with the TCI state and using the SSB as the QCL source for the TCI indicator state based at least in part on the first control information indicated via the RRC signaling at 410, the indication of the TCI state at 415, the cell switch command at 430, or any combination thereof. That is, the messages communicated with the candidate cell 405-b may be communicated using the spatial resources that are QCLed with the first resources for receipt of the SSB from the candidate cell 405-b based on the first control information.

In some cases, the UE 115-b and the candidate cell 405-b may be configured to revert back to using the CSI-RS (or other reference signal) as the QCL source for the TCI state. The timing of the switch to using the CSI-RS as the QCL state for the TCI state may be explicitly indicated by the candidate cell 405-b (step 445), implicitly determined (e.g., based on an expiration of some timer or timer interval at 450), or both.

At 445, the UE 115-b may receive a control message from the candidate cell 405-b, where the control message indicates a reference signal (e.g., CSI-RS) of the candidate cell 405-b. That is, the candidate cell 405-b may explicitly indicate that the UE 115-b is to switch from using the SSB resource(s) as the QCL source for the TCI state to using the CSI-RS as the QCL source.

At 450, the UE 115-b, the candidate cell 405-b, or both, may identify an expiration of a timer, where the expiration of the timer (or other time interval) serves as an implicit indication that the UE 115-b is to switch from using the SSB resource(s) as the QCL source for the TCI state to using the CSI-RS as the QCL source for the respective TCI state. In some cases, the timer may be configured or otherwise indicated via the RRC signaling at 410, via the indication of the TCI state at 415, via the cell switch command at 430, or any combination thereof. Moreover, in some aspects, the initiation/start of the timer may be explicitly indicated, or may be triggered via the cell switch command at 430 and/or completion of the cell switch at 435.

As such, the UE 115-b and the candidate cell 405-b may be configured to switch from using the SSB as the QCL source for the TCI state to using the CSI-RS (or other reference signal) as the QCL source based on the explicit control message at 445, based on the expiration of the timer at 450, or both.

At 455, the UE 115-b may perform communications with the candidate cell 405-b using the spatial resources for the TCI state, where the messages are communicated using the CSI-RS (or other reference signal) as the QCL source for the TCI state. The UE 115-b and the candidate cell 405-b may perform the communications using the reference signal (e.g., CSI-RS) as the QCL source for the TCI state (instead of using the SSB as the QCL source as was done at 440) based on the communication of the control message at 445, the expiration of the timer at 450, or both.

Techniques described herein may enable SSBs of the candidate cell 405-b to serve as a QCL source for TCI states activated for the candidate cell 405-b. As such, techniques described herein may facilitate cell switch/handover procedures performed by the UE 115-b by enabling the UE 115-b to derive QCL properties for TCI states based on SSBs of the candidate cell 405-b. In particular, in cases where CSI-RS configurations for a candidate cell are not received and/or processed at the UE 115-b until after a cell handover to the candidate cell 405-b has been completed, techniques described herein may enable the UE 115-b to derive QCL properties of the TCI state for the candidate cell 405-b using SSBs of the candidate cell 405-b, thereby enabling the UE 115-b to derive QCL properties prior to performing and/or completing the cell handover to the candidate cell 405-b.

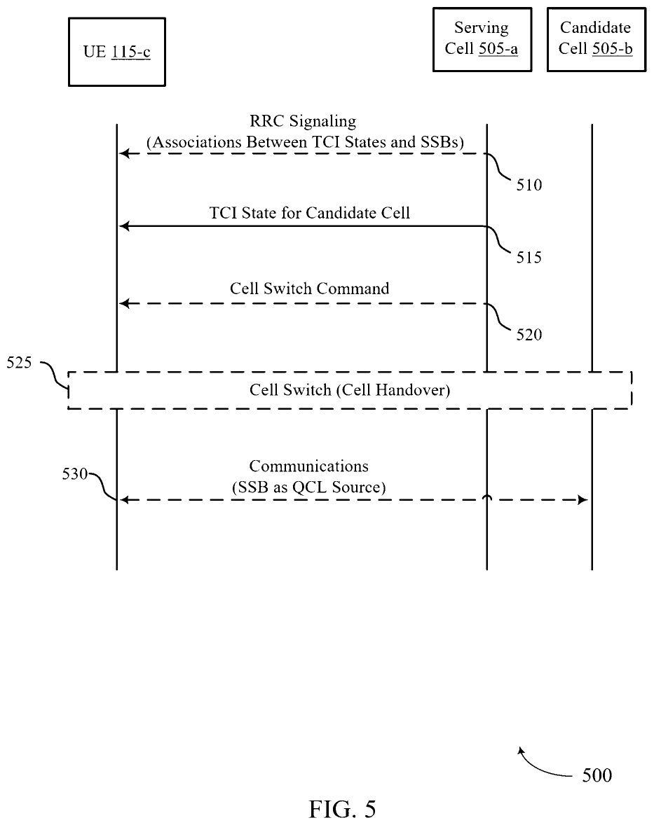

FIG. 5 shows an example of a process flow 500 that supports techniques for TCI association with candidate cell SSBs in accordance with one or more aspects of the present disclosure. Aspects of the process flow 500 may implement, or be implemented by, aspects of the wireless communications system 100, the wireless communications system 200, the timeline 300, the process flow 400, or any combination thereof. For example, the process flow 500 illustrates signaling and configurations that enable a UE 115-c to use SSBs of a candidate cell as a QCL source for a TCI state activated for the candidate cell, as described previously herein.

The process flow 500 includes a UE 115-c, a serving cell 505-a, and a candidate cell 505-b, which may be examples of UEs 115, network entities 105, serving cells 205, and other wireless devices as described herein. For example, the UE 115-c, the serving cell 505-a, and the candidate cell 505-b illustrated in FIG. 5 may include examples of the UE 115-a, the serving cell 205-a, and the candidate cell 205-b, respectively, as illustrated in FIG. 2. In this regard, the serving cell 505-a and the candidate cell 505-b may be associated with (e.g., supported by) the same or different network entities 105, and may be configured to communicate using the same or different frequency bands/RATs.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 510, the UE 115-c may receive an RRC message from the serving cell 505-a, where the RRC message indicates associations between TCI states and sets of resources for receiving SSBs (e.g., resources for receiving SSBs from the candidate cell 505-b). In other words, the RRC message may indicate a TCI state list, and SSB resources that correspond to the respective TCI states within the TCI state list.

At 515, the UE 115-c may receive, from the serving cell 505-a, an indication of a TCI state for communicating with the candidate cell 505-b. In some aspects, the TCI state is associated with a QCL source that indicates that spatial resources used by the UE 115-c for communications with the candidate cell 505-b are QCLed with an SSB of the candidate cell 505-b. In other words, the indication/activation of the TCI state may indicate an SSB resource of the candidate cell 505-b that is to be used as the QCL source for the activated TCI state when communicating with the candidate cell 505-b. In some cases, the applicable SSB resource(s) that serves as the QCL source for the indicated TCI state may be defined via the TCI state list indicated via the RRC signaling at 510. Additionally, or alternatively, the message at 515 indicating/activating the TCI state may also indicate which SSB resource(s) is to be used as the QCL source for the TCI state.

At 520, the UE 115-c may receive a cell switch command from the serving cell 505-a, where the cell switch command indicates for the UE 115-c to switch from serving cell 505-a to the candidate cell 505-b. The cell switch command may be communicated via a MAC-CE. In some aspects, the UE 115-c may receive the cell switch command based on receiving the RRC signaling at 510, receiving the indication/activation of the TCI state at 515, or both. Additionally, or alternatively, the indication of the TCI state and the cell switch command may be received via the same message (e.g., the cell switch command at 520 may indicate/activate the TCI state shown at 515).

At 525, the UE 115-c may perform the cell switch (e.g., cell handover) from the serving cell 505-a to the candidate cell 505-b. In some cases, performance of the cell switch/handover may include additional signaling between the UE 115-c and the respective cells, additional signaling between the serving cell 505-a and the candidate cell 505-b, or both.

At 530, the UE 115-c may perform communications with the candidate cell 505-b using the spatial resources for the TCI state, where the spatial resources are based on measurements performed by the UE 115-c on the corresponding SSB resources associated with the candidate cell 505-b. In other words, the UE 115-b may communicate PUSCH/PUCCH/PDSCH/PDCCH messages with the candidate cell 505-b in accordance with the TCI state that was indicated/activated at 515, where the TCI state is QCLed with the SSB resource(s) of the candidate cell 505-b (e.g., the SSB resource(s) serve as the QCL source for the TCI state).

Techniques described herein may enable SSBs of the candidate cell 505-b to serve as a QCL source for TCI states activated for the candidate cell 505-b. As such, techniques described herein may facilitate cell switch/handover procedures performed by the UE 115-c by enabling the UE 115-c to derive QCL properties for TCI states based on SSBs of the candidate cell 505-b. In particular, in cases where CSI-RS configurations for a candidate cell are not received and/or processed at the UE 115-c until after a cell handover to the candidate cell 505-b has been completed, techniques described herein may enable the UE 115-c to derive QCL properties of the TCI state for the candidate cell 505-b using SSBs of the candidate cell 505-b, thereby enabling the UE 115-c to derive QCL properties prior to performing and/or completing the cell handover to the candidate cell 505-b.

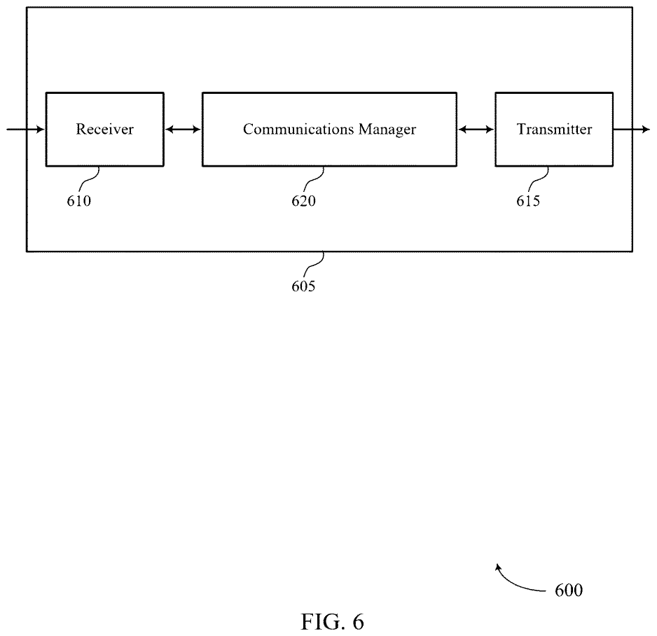

FIG. 6 shows a block diagram 600 of a device 605 that supports techniques for TCI association with candidate cell SSBs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for TCI association with candidate cell SSBs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for TCI association with candidate cell SSBs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for TCI association with candidate cell SSBs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor. If implemented in code executed by at least one processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell. The communications manager 620 is capable of, configured to, or operable to support a means for receiving, via the serving cell, first control information that is indicative of an association between the TCI state and first resources for receipt of an SSB from the candidate cell. The communications manager 620 is capable of, configured to, or operable to support a means for communicating one or more messages with the candidate cell using the spatial resources, where the spatial resources are based on the association between the first resources and the TCI state.

For example, the communications manager 620 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with an SSB of the candidate cell. The communications manager 620 is capable of, configured to, or operable to support a means for communicating one or more messages with the candidate cell using the spatial resources, where the spatial resources are based on measurements of the SSB.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques that enable SSBs of candidate cells to serve as a QCL source for TCI states activated for the candidate cells. As such, techniques described herein may facilitate cell switch/handover procedures performed by UEs 115 by enabling the UEs 115 to derive QCL properties for TCI states based on SSBs of the candidate cells. In particular, in cases where CSI-RS configurations for a candidate cell are not received and/or processed at the UE 115 until after a cell handover to the candidate cell has been completed, techniques described herein may enable the UE 115 to derive QCL properties of the TCI state for the candidate cell using SSBs of the candidate cell, thereby enabling the UE 115 to derive QCL properties prior to performing and/or completing the cell handover to the candidate cell.

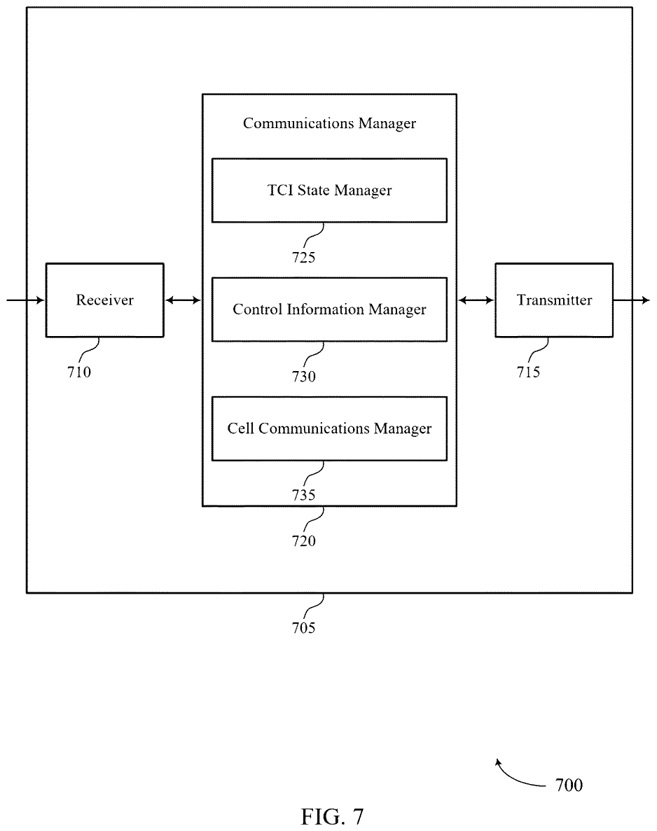

FIG. 7 shows a block diagram 700 of a device 705 that supports techniques for TCI association with candidate cell SSBs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for TCI association with candidate cell SSBs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for TCI association with candidate cell SSBs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for TCI association with candidate cell SSBs as described herein. For example, the communications manager 720 may include a TCI state manager 725, a control information manager 730, a cell communications manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The TCI state manager 725 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell. The control information manager 730 is capable of, configured to, or operable to support a means for receiving, via the serving cell, first control information that is indicative of an association between the TCI state and first resources for receipt of an SSB from the candidate cell. The cell communications manager 735 is capable of, configured to, or operable to support a means for communicating one or more messages with the candidate cell using the spatial resources, where the spatial resources are based on the association between the first resources and the TCI state.

The TCI state manager 725 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with an SSB of the candidate cell. The cell communications manager 735 is capable of, configured to, or operable to support a means for communicating one or more messages with the candidate cell using the spatial resources, where the spatial resources are based on measurements of the SSB.

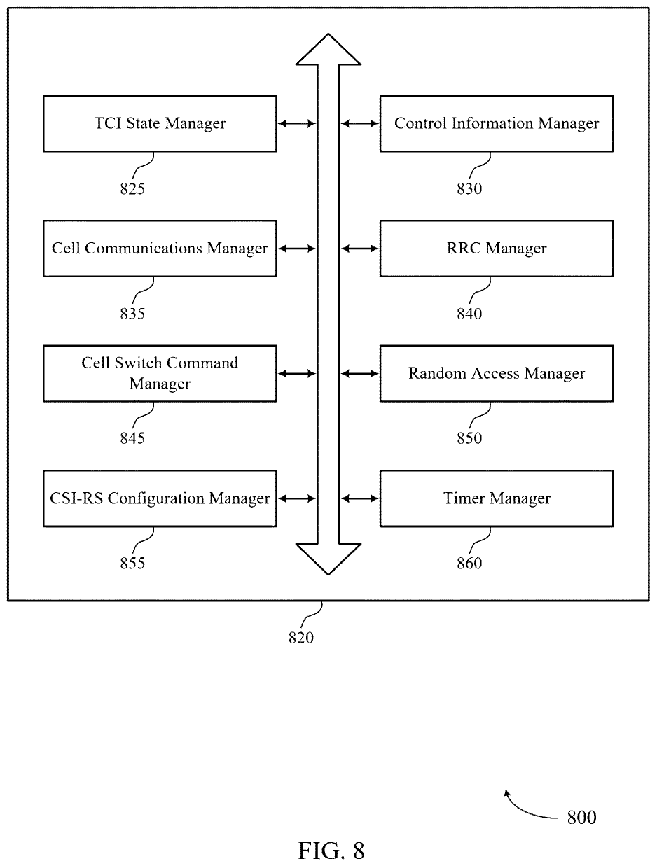

FIG. 8 shows a block diagram 800 of a communications manager 820 that supports techniques for TCI association with candidate cell SSBs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for TCI association with candidate cell SSBs as described herein. For example, the communications manager 820 may include a TCI state manager 825, a control information manager 830, a cell communications manager 835, an RRC manager 840, a cell switch command manager 845, a random access manager 850, a CSI-RS configuration manager 855, a timer manager 860, or any combination thereof. Each of these components, or components or subcomponents thereof (e.g., one or more processors, one or more memories), may communicate, directly or indirectly, with one another (e.g., via one or more buses).

The TCI state manager 825 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell. The control information manager 830 is capable of, configured to, or operable to support a means for receiving, via the serving cell, first control information that is indicative of an association between the TCI state and first resources for receipt of an SSB from the candidate cell. The cell communications manager 835 is capable of, configured to, or operable to support a means for communicating one or more messages with the candidate cell using the spatial resources, where the spatial resources are based on the association between the first resources and the TCI state.

In some examples, the one or more messages are communicated in accordance with the TCI state and using the SSB as the QCL source for the TCI state based on the first control information.

In some examples, the one or more messages are communicated using the spatial resources that are QCLed with the first resources for receipt of the SSB from the candidate cell based on the first control information.

In some examples, the RRC manager 840 is capable of, configured to, or operable to support a means for receiving an RRC message that indicates the association between the TCI state and the first resources for receipt of the SSB, where the TCI state is one of a set of TCI states included in the RRC message, each of the set of TCI states having corresponding sets of resources for receipt of one or more SSBs.

In some examples, the RRC manager 840 is capable of, configured to, or operable to support a means for receiving an RRC message indicating an additional association between the reference signal and the SSB, where the first control information is received via the RRC message, and where the association between the first resources and the TCI state is based on the additional association between the reference signal and the SSB.

In some examples, the first resources for receipt of the SSB include a downlink frequency resource, an SSB SCS, a PCID, an SSB index, or any combination thereof.

In some examples, the first control information is received via an RRC message. In some examples, the RRC message further indicates a TCI type associated with the TCI state for the candidate cell.

In some examples, the cell switch command manager 845 is capable of, configured to, or operable to support a means for receiving a cell switch command indicating for the UE to switch from the serving cell to the candidate cell, where the cell switch command includes the first control information.

In some examples, the cell switch command includes a MAC-CE message.

In some examples, the cell switch command further includes an activation of the TCI state for the candidate cell.

In some examples, the control information manager 830 is capable of, configured to, or operable to support a means for receiving second control information that is indicative of the TCI state and a downlink control channel order associated with a set of random access occasions, and where the set of random access occasions correspond to a set of SSBs including the SSB. In some examples, the random access manager 850 is capable of, configured to, or operable to support a means for transmitting, based on receiving the second control information, a first random access message via a random access occasion of the set of random access occasions, where the random access occasion corresponds to the SSB. In some examples, the random access manager 850 is capable of, configured to, or operable to support a means for receiving a second random access message in response to the first random access message, where the second random access message includes the first control information that is indicative of the association between the TCI state and first resources for receipt of the SSB.

In some examples, the control information manager 830 is capable of, configured to, or operable to support a means for receiving second control information indicating a set of TA values and corresponding sets of resources for receipt of SSBs, where the sets of resources include the first resources. In some examples, the cell switch command manager 845 is capable of, configured to, or operable to support a means for receiving a cell switch command including the indication of the TCI state and an indication of a TA value from the set of TA values, where the first control information is based on the indicated TA value corresponding to the first resources for receipt of the SSB indicated via the second control information.

In some examples, the CSI-RS configuration manager 855 is capable of, configured to, or operable to support a means for receiving, via the serving cell, an indication of a channel state information configuration for the reference signal of the candidate cell, where the first resources include a root QCL source associated with the reference signal, where the reference signal is a channel state information reference signal.

In some examples, the control information manager 830 is capable of, configured to, or operable to support a means for receiving, via the candidate cell, a control message indicating the reference signal of the candidate cell. In some examples, the cell communications manager 835 is capable of, configured to, or operable to support a means for communicating one or more additional messages with the candidate cell using the reference signal as the QCL source based on receiving the control message.

In some examples, the cell switch command manager 845 is capable of, configured to, or operable to support a means for receiving, via the serving cell, a cell switch command indicating for the UE to switch from the serving cell to the candidate cell, where the one or more messages are communicated using the SSB as the QCL source for the TCI state based on the first control information and the cell switch command. In some examples, the timer manager 860 is capable of, configured to, or operable to support a means for identifying an expiration of a timer based on receiving the cell switch command. In some examples, the cell communications manager 835 is capable of, configured to, or operable to support a means for communicating one or more additional messages with the candidate cell using the reference signal as the QCL source based on identifying the expiration of the timer.

In some examples, the timer manager 860 is capable of, configured to, or operable to support a means for receiving, via the serving cell, the candidate cell, or both, an indication of the timer, where identifying the expiration of the timer is based on receiving the indication of the timer.

In some examples, the indication of the TCI state and the first control information are received via a same control message.

In some examples, the QCL source indicates that the spatial resources used by the UE for communications with the candidate cell are QCLed with a channel-state information reference signal of the candidate cell.

In some examples, the TCI state manager 825 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with an SSB of the candidate cell. In some examples, the cell communications manager 835 is capable of, configured to, or operable to support a means for communicating one or more messages with the candidate cell using the spatial resources, where the spatial resources are based on measurements of the SSB.

In some examples, the cell switch command manager 845 is capable of, configured to, or operable to support a means for receiving, from the serving cell, a cell switch command indicating for the UE to switch from the serving cell to the candidate cell, where communicating the one or more messages is based on receiving the cell switch command.

In some examples, the indication of the TCI state is received via the cell switch command.

In some examples, the RRC manager 840 is capable of, configured to, or operable to support a means for receiving an RRC message indicating associations between a set of TCI states and sets of resources for receipt of SSBs, where the set of TCI states include the indicated TCI state, and where the sets of resources include first resources associated with the SSB, where receiving the indication of the TCI state is based on receiving the RRC message.

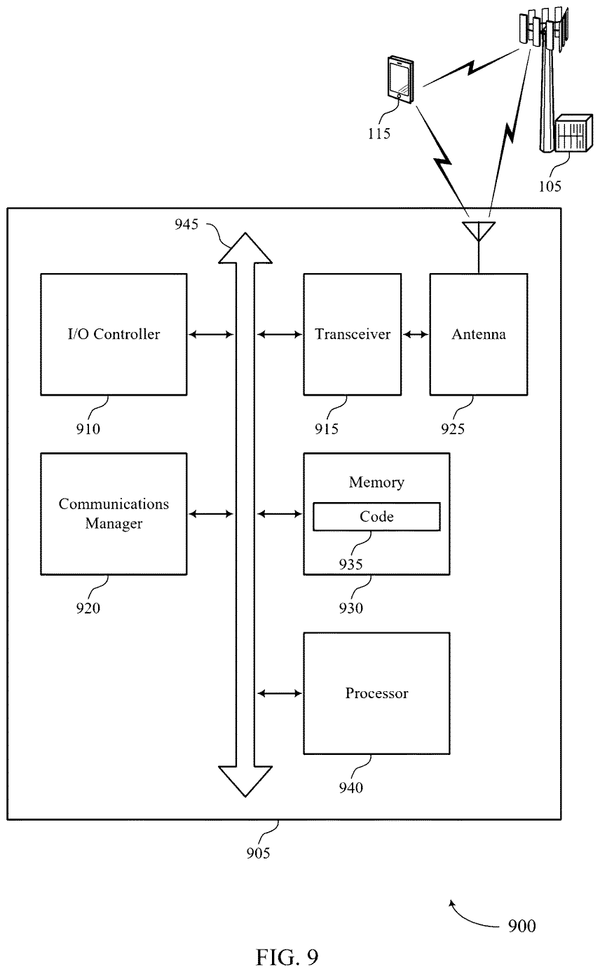

FIG. 9 shows a diagram of a system 900 including a device 905 that supports techniques for TCI association with candidate cell SSBs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for TCI association with candidate cell SSBs). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

For example, the communications manager 920 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell. The communications manager 920 is capable of, configured to, or operable to support a means for receiving, via the serving cell, first control information that is indicative of an association between the TCI state and first resources for receipt of an SSB from the candidate cell. The communications manager 920 is capable of, configured to, or operable to support a means for communicating one or more messages with the candidate cell using the spatial resources, where the spatial resources are based on the association between the first resources and the TCI state.

For example, the communications manager 920 is capable of, configured to, or operable to support a means for receiving, via a serving cell, an indication of a TCI state for communicating with a candidate cell, where the TCI state is associated with a QCL source that indicates that spatial resources used by the UE for communications with the candidate cell are QCLed with an SSB of the candidate cell. The communications manager 920 is capable of, configured to, or operable to support a means for communicating one or more messages with the candidate cell using the spatial resources, where the spatial resources are based on measurements of the SSB.

By including or configuring the communications manager 920 in accordance with examples as described herein, the device 905 may support techniques that enable SSBs of candidate cells to serve as a QCL source for TCI states activated for the candidate cells. As such, techniques described herein may facilitate cell switch/handover procedures performed by UEs 115 by enabling the UEs 115 to derive QCL properties for TCI states based on SSBs of the candidate cells. In particular, in cases where CSI-RS configurations for a candidate cell are not received and/or processed at the UE 115 until after a cell handover to the candidate cell has been completed, techniques described herein may enable the UE 115 to derive QCL properties of the TCI state for the candidate cell using SSBs of the candidate cell, thereby enabling the UE 115 to derive QCL properties prior to performing and/or completing the cell handover to the candidate cell.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for TCI association with candidate cell SSBs as described herein, or the at least one processor 940 and the at least one memory 930 may be otherwise configured to, individually or collectively, perform or support such operations.

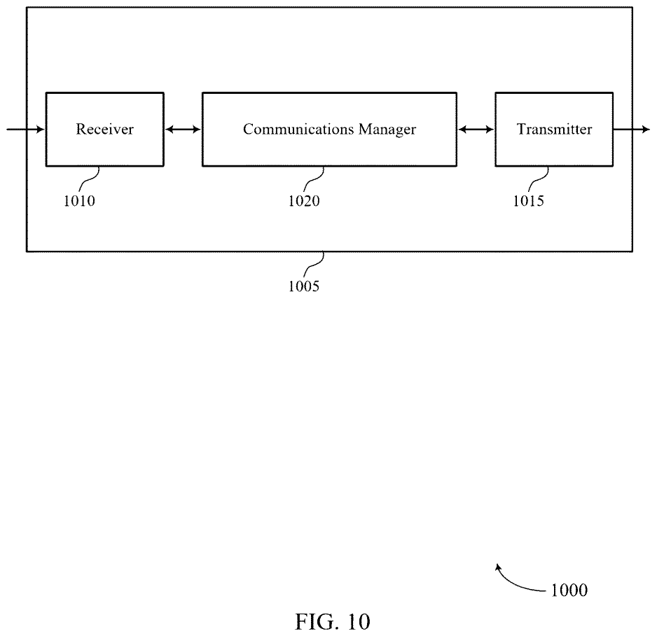

FIG. 10 shows a block diagram 1000 of a device 1005 that supports techniques for TCI association with candidate cell SSBs in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for TCI association with candidate cell SSBs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor. If implemented in code executed by at least one processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell. The communications manager 1020 is capable of, configured to, or operable to support a means for transmitting, via the serving cell, first control information that is indicative of an association between the TCI state and first resources for transmission of an SSB from the candidate cell. The communications manager 1020 is capable of, configured to, or operable to support a means for communicating one or more messages with the UE via the candidate cell using the spatial resources, where the spatial resources are based on the association between the first resources and the TCI state.

Additionally, or alternatively, the communications manager 1020 may support wireless communications in accordance with examples as disclosed herein. For example, the communications manager 1020 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell. The communications manager 1020 is capable of, configured to, or operable to support a means for communicating one or more messages with the UE via the candidate cell using the spatial resources, where the spatial resources are based on the SSB.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques that enable SSBs of candidate cells to serve as a QCL source for TCI states activated for the candidate cells. As such, techniques described herein may facilitate cell switch/handover procedures performed by UEs 115 by enabling the UEs 115 to derive QCL properties for TCI states based on SSBs of the candidate cells. In particular, in cases where CSI-RS configurations for a candidate cell are not received and/or processed at the UE 115 until after a cell handover to the candidate cell has been completed, techniques described herein may enable the UE 115 to derive QCL properties of the TCI state for the candidate cell using SSBs of the candidate cell, thereby enabling the UE 115 to derive QCL properties prior to performing and/or completing the cell handover to the candidate cell.

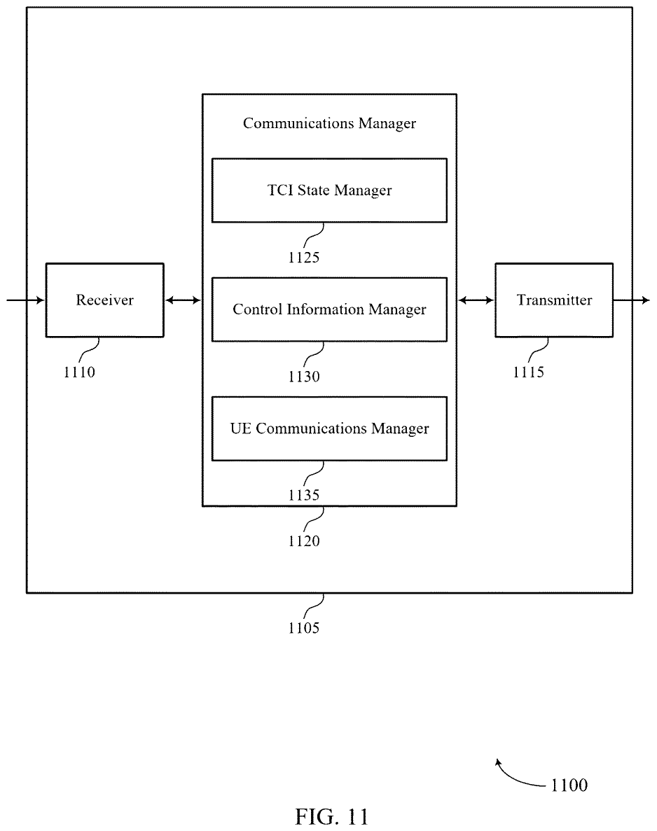

FIG. 11 shows a block diagram 1100 of a device 1105 that supports techniques for TCI association with candidate cell SSBs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for TCI association with candidate cell SSBs as described herein. For example, the communications manager 1120 may include a TCI state manager 1125, a control information manager 1130, a UE communications manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The TCI state manager 1125 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell. The control information manager 1130 is capable of, configured to, or operable to support a means for transmitting, via the serving cell, first control information that is indicative of an association between the TCI state and first resources for transmission of an SSB from the candidate cell. The UE communications manager 1135 is capable of, configured to, or operable to support a means for communicating one or more messages with the UE via the candidate cell using the spatial resources, where the spatial resources are based on the association between the first resources and the TCI state.

Additionally, or alternatively, the communications manager 1120 may support wireless communications in accordance with examples as disclosed herein. The TCI state manager 1125 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell. The UE communications manager 1135 is capable of, configured to, or operable to support a means for communicating one or more messages with the UE via the candidate cell using the spatial resources, where the spatial resources are based on the SSB.

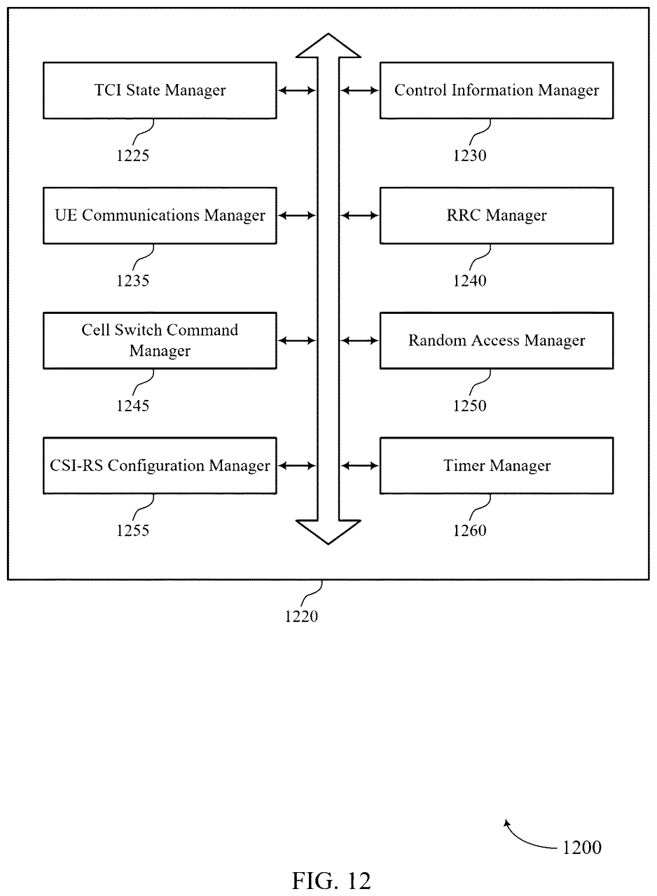

FIG. 12 shows a block diagram 1200 of a communications manager 1220 that supports techniques for TCI association with candidate cell SSBs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for TCI association with candidate cell SSBs as described herein. For example, the communications manager 1220 may include a TCI state manager 1225, a control information manager 1230, a UE communications manager 1235, an RRC manager 1240, a cell switch command manager 1245, a random access manager 1250, a CSI-RS configuration manager 1255, a timer manager 1260, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The TCI state manager 1225 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell. The control information manager 1230 is capable of, configured to, or operable to support a means for transmitting, via the serving cell, first control information that is indicative of an association between the TCI state and first resources for transmission of an SSB from the candidate cell. The UE communications manager 1235 is capable of, configured to, or operable to support a means for communicating one or more messages with the UE via the candidate cell using the spatial resources, where the spatial resources are based on the association between the first resources and the TCI state.

In some examples, the one or more messages are communicated in accordance with the TCI state and using the SSB as the QCL source for the TCI state based on the first control information.

In some examples, the one or more messages are communicated using the spatial resources that are QCLed with the first resources for transmission of the SSB from the candidate cell based on the first control information.

In some examples, the RRC manager 1240 is capable of, configured to, or operable to support a means for transmitting an RRC message that indicates the association between the TCI state and the first resources for transmission of the SSB, where the TCI state is one of a set of TCI states included in the RRC message, each of the set of TCI states having corresponding sets of resources for transmission of one or more SSBs.

In some examples, the RRC manager 1240 is capable of, configured to, or operable to support a means for receiving an RRC message indicating an additional association between the reference signal and the SSB, where the first control information is transmitted via the RRC message, and where the association between the first resources and the TCI state is based on the additional association between the reference signal and the SSB.

In some examples, the first resources for transmission of the SSB include a downlink frequency resource, an SSB SCS, a PCID, an SSB index, or any combination thereof.

In some examples, the first control information is transmitted via an RRC message. In some examples, the RRC message further indicates a TCI type associated with the TCI state for the candidate cell.

In some examples, the cell switch command manager 1245 is capable of, configured to, or operable to support a means for transmitting a cell switch command indicating for the UE to switch from the serving cell to the candidate cell, where the cell switch command includes the first control information.

In some examples, the cell switch command includes a MAC-CE message.

In some examples, the cell switch command further includes an activation of the TCI state for the candidate cell.

In some examples, the control information manager 1230 is capable of, configured to, or operable to support a means for transmitting second control information that is indicative of the TCI state and a downlink control channel order associated with a set of random access occasions, and where the set of random access occasions correspond to a set of SSBs including the SSB. In some examples, the random access manager 1250 is capable of, configured to, or operable to support a means for receiving, based on transmitting the second control information, a of first random access message via a random access occasion of the set of random access occasions, where the random access occasion corresponds to the SSB. In some examples, the random access manager 1250 is capable of, configured to, or operable to support a means for transmitting a second random access message in response to the first random access message, where the second random access message includes the first control information that is indicative of the association between the TCI state and first resources for transmission of the SSB.

In some examples, the control information manager 1230 is capable of, configured to, or operable to support a means for transmitting second control information indicating a set of TA values and corresponding sets of resources for transmission of SSBs, where the sets of resources include the first resources. In some examples, the cell switch command manager 1245 is capable of, configured to, or operable to support a means for transmitting a cell switch command including the indication of the TCI state and an indication of a TA value from the set of TA values, where the first control information is based on the indicated TA value corresponding to the first resources for transmission of the SSB indicated via the second control information.

In some examples, the CSI-RS configuration manager 1255 is capable of, configured to, or operable to support a means for transmitting, via the serving cell, an indication of a channel state information configuration for the reference signal of the candidate cell, where the first resources include a root QCL source associated with the reference signal, where the reference signal is a channel state information reference signal.

In some examples, the one or more messages are communicated using the SSB as the QCL source for the TCI state based on the first control information, and the control information manager 1230 is capable of, configured to, or operable to support a means for transmitting, via the candidate cell, a control message indicating the reference signal of the candidate cell. In some examples, the one or more messages are communicated using the SSB as the QCL source for the TCI state based on the first control information, and the UE communications manager 1235 is capable of, configured to, or operable to support a means for communicating one or more additional messages via the candidate cell using the reference signal as the QCL source based on transmitting the control message.

In some examples, the cell switch command manager 1245 is capable of, configured to, or operable to support a means for transmitting, via the serving cell, a cell switch command indicating for the UE to switch from the serving cell to the candidate cell, where the one or more messages are communicated using the SSB as the QCL source for the TCI state based on the first control information and the cell switch command. In some examples, the timer manager 1260 is capable of, configured to, or operable to support a means for identifying an expiration of a timer based on receiving the cell switch command.

In some examples, the timer manager 1260 is capable of, configured to, or operable to support a means for transmitting, via the serving cell, the candidate cell, or both, an indication of the timer, where identifying the expiration of the timer is based on transmitting the indication of the timer.

In some examples, the indication of the TCI state and the first control information are transmitted via a same control message.

In some examples, the QCL source indicates that the spatial resources used by the UE for communications with the candidate cell are QCLed with a channel-state information reference signal of the candidate cell.

Additionally, or alternatively, the communications manager 1220 may support wireless communications in accordance with examples as disclosed herein. In some examples, the TCI state manager 1225 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell. In some examples, the UE communications manager 1235 is capable of, configured to, or operable to support a means for communicating one or more messages with the UE via the candidate cell using the spatial resources, where the spatial resources are based on the SSB.

In some examples, the cell switch command manager 1245 is capable of, configured to, or operable to support a means for transmitting, from the serving cell, a cell switch command indicating for the UE to switch from the serving cell to the candidate cell, where communicating the one or more messages is based on transmitting the cell switch command.

In some examples, the indication of the TCI state is transmitted via the cell switch command.

In some examples, the RRC manager 1240 is capable of, configured to, or operable to support a means for transmitting an RRC message indicating associations between a set of TCI states and sets of resources for receipt of SSBs, where the set of TCI states include the indicated TCI state, and where the sets of resources include first resources associated with the SSB, where transmitting the indication of the TCI state is based on transmitting the RRC message.

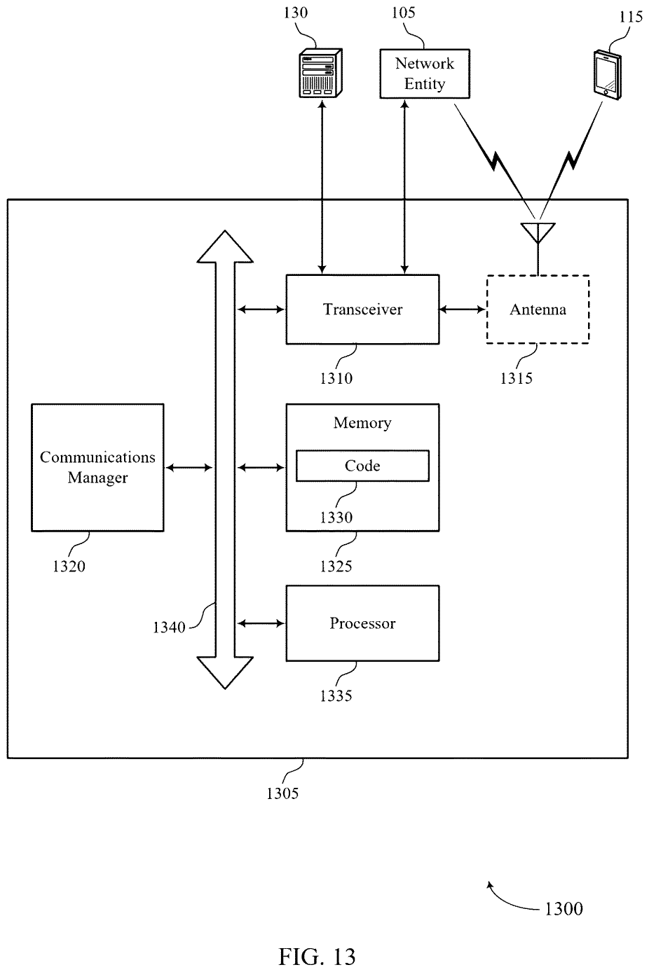

FIG. 13 shows a diagram of a system 1300 including a device 1305 that supports techniques for TCI association with candidate cell SSBs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for TCI association with candidate cell SSBs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some implementations, the at least one processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the at least one processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell. The communications manager 1320 is capable of, configured to, or operable to support a means for transmitting, via the serving cell, first control information that is indicative of an association between the TCI state and first resources for transmission of an SSB from the candidate cell. The communications manager 1320 is capable of, configured to, or operable to support a means for communicating one or more messages with the UE via the candidate cell using the spatial resources, where the spatial resources are based on the association between the first resources and the TCI state.

Additionally, or alternatively, the communications manager 1320 may support wireless communications in accordance with examples as disclosed herein. For example, the communications manager 1320 is capable of, configured to, or operable to support a means for transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell. The communications manager 1320 is capable of, configured to, or operable to support a means for communicating one or more messages with the UE via the candidate cell using the spatial resources, where the spatial resources are based on the SSB.

By including or configuring the communications manager 1320 in accordance with examples as described herein, the device 1305 may support techniques that enable SSBs of candidate cells to serve as a QCL source for TCI states activated for the candidate cells. As such, techniques described herein may facilitate cell switch/handover procedures performed by UEs 115 by enabling the UEs 115 to derive QCL properties for TCI states based on SSBs of the candidate cells. In particular, in cases where CSI-RS configurations for a candidate cell are not received and/or processed at the UE 115 until after a cell handover to the candidate cell has been completed, techniques described herein may enable the UE 115 to derive QCL properties of the TCI state for the candidate cell using SSBs of the candidate cell, thereby enabling the UE 115 to derive QCL properties prior to performing and/or completing the cell handover to the candidate cell.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for TCI association with candidate cell SSBs as described herein, or the at least one processor 1335 and the at least one memory 1325 may be otherwise configured to, individually or collectively, perform or support such operations.

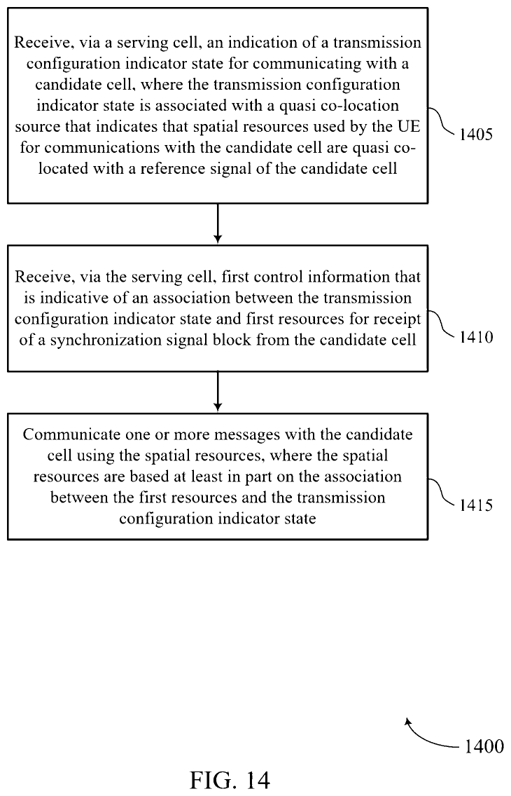

FIG. 14 shows a flowchart illustrating a method 1400 that supports techniques for TCI association with candidate cell SSBs in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, via a serving cell, an indication of a TCI state for communicating with a candidate cell, where the TCI state is associated with a QCL source that indicates that spatial resources used by the UE for communications with the candidate cell are QCLed with a reference signal of the candidate cell. The operations of block 1405 may be performed in accordance with examples as disclosed herein. In some examples, aspects of the operations of 1405 may be performed by a TCI state manager 825 as described with reference to FIG. 8.

At 1410, the method may include receiving, via the serving cell, first control information that is indicative of an association between the TCI state and first resources for receipt of an SSB from the candidate cell. The operations of block 1410 may be performed in accordance with examples as disclosed herein. In some examples, aspects of the operations of 1410 may be performed by a control information manager 830 as described with reference to FIG. 8.

At 1415, the method may include communicating one or more messages with the candidate cell using the spatial resources, where the spatial resources are based at least in part on the association between the first resources and the TCI state. The operations of block 1415 may be performed in accordance with examples as disclosed herein. In some examples, aspects of the operations of 1415 may be performed by a cell communications manager 835 as described with reference to FIG. 8.

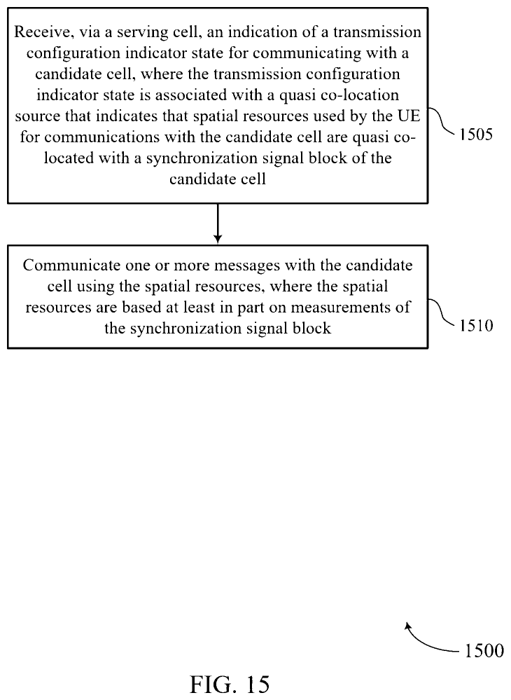

FIG. 15 shows a flowchart illustrating a method 1500 that supports techniques for TCI association with candidate cell SSBs in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, via a serving cell, an indication of a TCI state for communicating with a candidate cell, where the TCI state is associated with a QCL source that indicates that spatial resources used by the UE for communications with the candidate cell are QCLed with an SSB of the candidate cell. The operations of block 1505 may be performed in accordance with examples as disclosed herein. In some examples, aspects of the operations of 1505 may be performed by a TCI state manager 825 as described with reference to FIG. 8.

At 1510, the method may include communicating one or more messages with the candidate cell using the spatial resources, where the spatial resources are based at least in part on measurements of the SSB. The operations of block 1510 may be performed in accordance with examples as disclosed herein. In some examples, aspects of the operations of 1510 may be performed by a cell communications manager 835 as described with reference to FIG. 8.

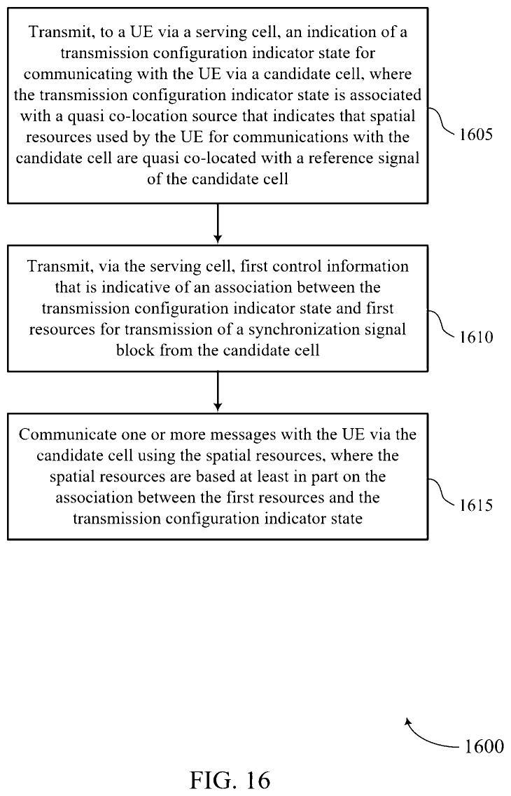

FIG. 16 shows a flowchart illustrating a method 1600 that supports techniques for TCI association with candidate cell SSBs in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE via a serving cell, an indication of a TCI state for communicating with the UE via a candidate cell, where the TCI state is associated with a QCL source that indicates that spatial resources used by the UE for communications with the candidate cell are QCLed with a reference signal of the candidate cell. The operations of block 1605 may be performed in accordance with examples as disclosed herein. In some examples, aspects of the operations of 1605 may be performed by a TCI state manager 1225 as described with reference to FIG. 12.

At 1610, the method may include transmitting, via the serving cell, first control information that is indicative of an association between the TCI state and first resources for transmission of an SSB from the candidate cell. The operations of block 1610 may be performed in accordance with examples as disclosed herein. In some examples, aspects of the operations of 1610 may be performed by a control information manager 1230 as described with reference to FIG. 12.

At 1615, the method may include communicating one or more messages with the UE via the candidate cell using the spatial resources, where the spatial resources are based at least in part on the association between the first resources and the TCI state. The operations of block 1615 may be performed in accordance with examples as disclosed herein. In some examples, aspects of the operations of 1615 may be performed by a UE communications manager 1235 as described with reference to FIG. 12.

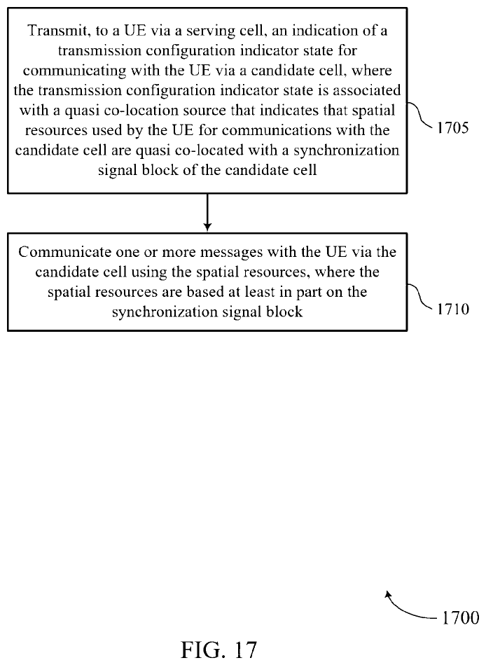

FIG. 17 shows a flowchart illustrating a method 1700 that supports techniques for TCI association with candidate cell SSBs in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE via a serving cell, an indication of a TCI state for communicating with the UE via a candidate cell, where the TCI state is associated with a QCL source that indicates that spatial resources used by the UE for communications with the candidate cell are QCLed with an SSB of the candidate cell. The operations of block 1705 may be performed in accordance with examples as disclosed herein. In some examples, aspects of the operations of 1705 may be performed by a TCI state manager 1225 as described with reference to FIG. 12.

At 1710, the method may include communicating one or more messages with the UE via the candidate cell using the spatial resources, where the spatial resources are based at least in part on the SSB. The operations of block 1710 may be performed in accordance with examples as disclosed herein. In some examples, aspects of the operations of 1710 may be performed by a UE communications manager 1235 as described with reference to FIG. 12.

The following provides an overview of aspects of the present disclosure:
Aspect 1: A method for wireless communications at a UE, comprising: receiving, via a serving cell, an indication of a TCI state for communicating with a candidate cell, wherein the TCI state is associated with a QCL source that indicates that spatial resources used by the UE for communications with the candidate cell are QCLed with a reference signal of the candidate cell; receiving, via the serving cell, first control information that is indicative of an association between the TCI state and first resources for receipt of an SSB from the candidate cell; and communicating one or more messages with the candidate cell using the spatial resources, wherein the spatial resources are based at least in part on the association between the first resources and the TCI state.
Aspect 2: The method of aspect 1, wherein the one or more messages are communicated in accordance with the TCI state and using the SSB as the QCL source for the TCI state based at least in part on the first control information.
Aspect 3: The method of any of aspects 1 through 2, wherein the one or more messages are communicated using the spatial resources that are QCLed with the first resources for receipt of the SSB from the candidate cell based at least in part on the first control information.
Aspect 4: The method of any of aspects 1 through 3, further comprising: receiving an RRC message that indicates the association between the TCI state and the first resources for receipt of the SSB, wherein the TCI state is one of a set of TCI states included in the RRC message, each of the set of TCI states having corresponding sets of resources for receipt of one or more SSBs.
Aspect 5: The method of any of aspects 1 through 4, further comprising: receiving an RRC message indicating an additional association between the reference signal and the SSB, wherein the first control information is received via the RRC message, and wherein the association between the first resources and the TCI state is based at least in part on the additional association between the reference signal and the SSB.
Aspect 6: The method of aspect 5, wherein the first resources for receipt of the SSB comprise a downlink frequency resource, an SSB SCS, a PCID, an SSB index, or any combination thereof.
Aspect 7: The method of any of aspects 1 through 6, wherein the first control information is received via an RRC message, the RRC message further indicates a TCI type associated with the TCI state for the candidate cell.
Aspect 8: The method of any of aspects 1 through 7, further comprising: receiving a cell switch command indicating for the UE to switch from the serving cell to the candidate cell, wherein the cell switch command comprises the first control information.
Aspect 9: The method of aspect 8, wherein the cell switch command comprises a MAC-CE message.
Aspect 10: The method of any of aspects 8 through 9, wherein the cell switch command further comprises an activation of the TCI state for the candidate cell.
Aspect 11: The method of any of aspects 1 through 10, further comprising: receiving second control information that is indicative of the TCI state and a downlink control channel order associated with a set of random access occasions, and wherein the set of random access occasions correspond to a set of SSBs including the SSB; transmitting, based at least in part on receiving the second control information, a first random access message via a random access occasion of the set of random access occasions, wherein the random access occasion corresponds to the SSB; and receiving a second random access message in response to the first random access message, wherein the second random access message comprises the first control information that is indicative of the association between the TCI state and first resources for receipt of the SSB.
Aspect 12: The method of any of aspects 1 through 11, further comprising: receiving second control information indicating a set of TA values and corresponding sets of resources for receipt of SSBs, wherein the sets of resources include the first resources; and receiving a cell switch command comprising the indication of the TCI state and an indication of a TA value from the set of TA values, wherein the first control information is based at least in part on the indicated TA value corresponding to the first resources for receipt of the SSB indicated via the second control information.
Aspect 13: The method of any of aspects 1 through 12, further comprising: receiving, via the serving cell, an indication of a channel state information configuration for the reference signal of the candidate cell, wherein the first resources comprise a root QCL source associated with the reference signal, wherein the reference signal is a CSI-RS.
Aspect 14: The method of any of aspects 1 through 13, wherein the one or more messages are communicated using the SSB as the QCL source for the TCI state based at least in part on the first control information, the method further comprising: receiving, via the candidate cell, a control message indicating the reference signal of the candidate cell; and communicating one or more additional messages with the candidate cell using the reference signal as the QCL source based at least in part on receiving the control message.
Aspect 15: The method of any of aspects 1 through 14, the method further comprising: receiving, via the serving cell, a cell switch command indicating for the UE to switch from the serving cell to the candidate cell, wherein the one or more messages are communicated using the SSB as the QCL source for the TCI state based at least in part on the first control information and the cell switch command; identifying an expiration of a timer based at least in part on receiving the cell switch command; and communicating one or more additional messages with the candidate cell using the reference signal as the QCL source based at least in part on identifying the expiration of the timer.
Aspect 16: The method of aspect 15, the method further comprising: receiving, via the serving cell, the candidate cell, or both, an indication of the timer, wherein identifying the expiration of the timer is based at least in part on receiving the indication of the timer.
Aspect 17: The method of any of aspects 1 through 16, wherein the indication of the TCI state and the first control information are received via a same control message.
Aspect 18: The method of any of aspects 1 through 17, wherein the QCL source indicates that the spatial resources used by the UE for communications with the candidate cell are QCLed with a channel-state information reference signal of the candidate cell.
Aspect 19: A method for wireless communications at a UE, comprising: receiving, via a serving cell, an indication of a TCI state for communicating with a candidate cell, wherein the TCI state is associated with a QCL source that indicates that spatial resources used by the UE for communications with the candidate cell are QCLed with an SSB of the candidate cell; and communicating one or more messages with the candidate cell using the spatial resources, wherein the spatial resources are based at least in part on measurements of the SSB.
Aspect 20: The method of aspect 19, further comprising: receiving, from the serving cell, a cell switch command indicating for the UE to switch from the serving cell to the candidate cell, wherein communicating the one or more messages is based at least in part on receiving the cell switch command.
Aspect 21: The method of aspect 20, wherein the indication of the TCI state is received via the cell switch command.
Aspect 22: The method of any of aspects 19 through 21, further comprising: receiving an RRC message indicating associations between a set of TCI states and sets of resources for receipt of SSBs, wherein the set of TCI states include the indicated TCI state, and wherein the sets of resources include first resources associated with the SSB, wherein receiving the indication of the TCI state is based at least in part on receiving the RRC message.
Aspect 23: A method for wireless communications at a network entity, comprising: transmitting, to a UE via a serving cell, an indication of a TCI state for communicating with the UE via a candidate cell, wherein the TCI state is associated with a QCL source that indicates that spatial resources used by the UE for communications with the candidate cell are QCLed with a reference signal of the candidate cell; transmitting, via the serving cell, first control information that is indicative of an association between the TCI state and first resources for transmission of an SSB from the candidate cell; and communicating one or more messages with the UE via the candidate cell using the spatial resources, wherein the spatial resources are based at least in part on the association between the first resources and the TCI state.
Aspect 24: The method of aspect 23, wherein the one or more messages are communicated in accordance with the TCI state and using the SSB as the QCL source for the TCI state based at least in part on the first control information.
Aspect 25: The method of any of aspects 23 through 24, wherein the one or more messages are communicated using the spatial resources that are QCLed with the first resources for transmission of the SSB from the candidate cell based at least in part on the first control information.
Aspect 26: The method of any of aspects 23 through 25, further comprising: transmitting an RRC message that indicates the association between the TCI state and the first resources for transmission of the SSB, wherein the TCI state is one of a set of TCI states included in the RRC message, each of the set of TCI states having corresponding sets of resources for transmission of one or more SSBs.
Aspect 27: The method of any of aspects 23 through 26, further comprising: receiving an RRC message indicating an additional association between the reference signal and the SSB, wherein the first control information is transmitted via the RRC message, and wherein the association between the first resources and the TCI state is based at least in part on the additional association between the reference signal and the SSB.
Aspect 28: The method of aspect 27, wherein the first resources for transmission of the SSB comprise a downlink frequency resource, an SSB SCS, a PCID, an SSB index, or any combination thereof.
Aspect 29: The method of any of aspects 23 through 28, wherein the first control information is transmitted via an RRC message, the RRC message further indicates a TCI type associated with the TCI state for the candidate cell.
Aspect 30: The method of any of aspects 23 through 29, further comprising: transmitting a cell switch command indicating for the UE to switch from the serving cell to the candidate cell, wherein the cell switch command comprises the first control information.
Aspect 31: The method of aspect 30, wherein the cell switch command comprises a MAC-CE message.
Aspect 32: The method of any of aspects 30 through 31, wherein the cell switch command further comprises an activation of the TCI state for the candidate cell.
Aspect 33: The method of any of aspects 23 through 32, further comprising: transmitting second control information that is indicative of the TCI state and a downlink control channel order associated with a set of random access occasions, and wherein the set of random access occasions correspond to a set of SSBs including the SSB; receiving, based at least in part on transmitting the second control information, a of first random access message via a random access occasion of the set of random access occasions, wherein the random access occasion corresponds to the SSB; and transmitting a second random access message in response to the first random access message, wherein the second random access message comprises the first control information that is indicative of the association between the TCI state and first resources for transmission of the SSB.
Aspect 34: The method of any of aspects 23 through 33, further comprising: transmitting second control information indicating a set of TA values and corresponding sets of resources for transmission of SSBs, wherein the sets of resources include the first resources; and transmitting a cell switch command comprising the indication of the TCI state and an indication of a TA value from the set of TA values, wherein the first control information is based at least in part on the indicated TA value corresponding to the first resources for transmission of the SSB indicated via the second control information.
Aspect 35: The method of any of aspects 23 through 34, further comprising: transmitting, via the serving cell, an indication of a channel state information configuration for the reference signal of the candidate cell, wherein the first resources comprise a root QCL source associated with the reference signal, wherein the reference signal is a CSI-RS.
Aspect 36: The method of any of aspects 23 through 35, wherein the one or more messages are communicated using the SSB as the QCL source for the TCI state based at least in part on the first control information, the method further comprising: transmitting, via the candidate cell, a control message indicating the reference signal of the candidate cell; and communicating one or more additional messages via the candidate cell using the reference signal as the QCL source based at least in part on transmitting the control message.
Aspect 37: The method of any of aspects 23 through 36, further comprising: transmitting, via the serving cell, a cell switch command indicating for the UE to switch from the serving cell to the candidate cell, wherein the one or more messages are communicated using the SSB as the QCL source for the TCI state based at least in part on the first control information and the cell switch command; identifying an expiration of a timer based at least in part on receiving the cell switch command; and communicating one or more additional messages with the UE using the reference signal as the QCL source based at least in part on identifying the expiration of the timer.
Aspect 38: The method of aspect 37, further comprising: transmitting, via the serving cell, the candidate cell, or both, an indication of the timer, wherein identifying the expiration of the timer is based at least in part on transmitting the indication of the timer.
Aspect 39: The method of any of aspects 23 through 38, wherein the indication of the TCI state and the first control information are transmitted via a same control message.
Aspect 40: The method of any of aspects 23 through 39, wherein the QCL source indicates that the spatial resources used by the UE for communications with the candidate cell are QCLed with a channel-state information reference signal of the candidate cell.
Aspect 41: A method for wireless communications at a network entity, comprising: transmitting, to a UE via a serving cell, an indication of a TCI state for communicating with the UE via a candidate cell, wherein the TCI state is associated with a QCL source that indicates that spatial resources used by the UE for communications with the candidate cell are QCLed with an SSB of the candidate cell; and communicating one or more messages with the UE via the candidate cell using the spatial resources, wherein the spatial resources are based at least in part on the SSB.
Aspect 42: The method of aspect 41, further comprising: transmitting, from the serving cell, a cell switch command indicating for the UE to switch from the serving cell to the candidate cell, wherein communicating the one or more messages is based at least in part on transmitting the cell switch command.
Aspect 43: The method of aspect 42, wherein the indication of the TCI state is transmitted via the cell switch command.
Aspect 44: The method of any of aspects 41 through 43, further comprising: transmitting an RRC message indicating associations between a set of TCI states and sets of resources for receipt of SSBs, wherein the set of TCI states include the indicated TCI state, and wherein the sets of resources include first resources associated with the SSB, wherein transmitting the indication of the TCI state is based at least in part on transmitting the RRC message.
Aspect 45: A UE comprising one or more memories storing processor-executable code, and one or more processors coupled with the one or more memories and individually or collectively operable to execute the code to cause the UE to perform a method of any of aspects 1 through 18.
Aspect 46: A UE comprising at least one means for performing a method of any of aspects 1 through 18.
Aspect 47: A non-transitory computer-readable medium storing code the code comprising instructions executable by a processor to perform a method of any of aspects 1 through 18.
Aspect 48: A UE comprising one or more memories storing processor-executable code, and one or more processors coupled with the one or more memories and individually or collectively operable to execute the code to cause the UE to perform a method of any of aspects 19 through 22.
Aspect 49: A UE comprising at least one means for performing a method of any of aspects 19 through 22.
Aspect 50: A non-transitory computer-readable medium storing code the code comprising instructions executable by a processor to perform a method of any of aspects 19 through 22.
Aspect 51: A network entity for wireless communications, comprising one or more memories storing processor-executable code, and one or more processors coupled with the one or more memories and individually or collectively operable to execute the code to cause the network entity to perform a method of any of aspects 23 through 40.
Aspect 52: A network entity for wireless communications, comprising at least one means for performing a method of any of aspects 23 through 40.
Aspect 53: A non-transitory computer-readable medium storing code for wireless communications, the code comprising instructions executable by a processor to perform a method of any of aspects 23 through 40.
Aspect 54: A network entity for wireless communications, comprising one or more memories storing processor-executable code, and one or more processors coupled with the one or more memories and individually or collectively operable to execute the code to cause the network entity to perform a method of any of aspects 41 through 44.
Aspect 55: A network entity for wireless communications, comprising at least one means for performing a method of any of aspects 41 through 44.
Aspect 56: A non-transitory computer-readable medium storing code for wireless communications, the code comprising instructions executable by a processor to perform a method of any of aspects 41 through 44.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, the at least one memory storing instructions executable by the at least one processor to cause the UE to:
receive, via a serving cell, an indication of a transmission configuration indicator state for communicating with a candidate cell, wherein the transmission configuration indicator state is associated with a quasi co-location source that indicates that spatial resources used by the UE for communications with the candidate cell are quasi co-located with a reference signal of the candidate cell;
receive, via the serving cell, first control information that is indicative of an association between the transmission configuration indicator state and first resources for receipt of a synchronization signal block from the candidate cell; and
communicate one or more messages with the candidate cell using the spatial resources, wherein the spatial resources are based at least in part on the association between the first resources and the transmission configuration indicator state.

2. The UE of claim 1, wherein the one or more messages are communicated in accordance with the transmission configuration indicator state and using the synchronization signal block as the quasi co-location source for the transmission configuration indicator state based at least in part on the first control information.

3. The UE of claim 1, wherein the one or more messages are communicated using the spatial resources that are quasi co-located with the first resources for receipt of the synchronization signal block from the candidate cell based at least in part on the first control information.

4. The UE of claim 1, wherein the at least one processor is further operable to execute the instructions to cause the UE to:
receive a radio resource control message that indicates the association between the transmission configuration indicator state and the first resources for receipt of the synchronization signal block, wherein the transmission configuration indicator state is one of a set of transmission configuration indicator states included in the radio resource control message, each of the set of transmission configuration indicator states having corresponding sets of resources for receipt of one or more synchronization signal blocks.

5. The UE of claim 1, wherein the at least one processor is further operable to execute the instructions to cause the UE to:
receive a radio resource control message indicating an additional association between the reference signal and the synchronization signal block, wherein the first control information is received via the radio resource control message, and wherein the association between the first resources and the transmission configuration indicator state is based at least in part on the additional association between the reference signal and the synchronization signal block.

6. The UE of claim 5, wherein the first resources for receipt of the synchronization signal block comprise a downlink frequency resource, a synchronization signal block subcarrier spacing, a physical cell identifier, a synchronization signal block index, or any combination thereof.

7. The UE of claim 1, wherein the first control information is received via a radio resource control message, wherein the radio resource control message further indicates a transmission configuration indicator type associated with the transmission configuration indicator state for the candidate cell.

8. The UE of claim 1, wherein the at least one processor is further operable to execute the instructions to cause the UE to:
receive a cell switch command indicating for the UE to switch from the serving cell to the candidate cell, wherein the cell switch command comprises the first control information.

9. The UE of claim 8, wherein the cell switch command comprises a medium access control-control element message.

10. The UE of claim 8, wherein the cell switch command further comprises an activation of the transmission configuration indicator state for the candidate cell.

11. The UE of claim 1, wherein the at least one processor is further operable to execute the instructions to cause the UE to:
receive second control information that is indicative of the transmission configuration indicator state and a downlink control channel order associated with a set of random access occasions, and wherein the set of random access occasions correspond to a set of synchronization signal blocks including the synchronization signal block;
transmit, based at least in part on receiving the second control information, a first random access message via a random access occasion of the set of random access occasions, wherein the random access occasion corresponds to the synchronization signal block; and
receive a second random access message in response to the first random access message, wherein the second random access message comprises the first control information that is indicative of the association between the transmission configuration indicator state and first resources for receipt of the synchronization signal block.

12. The UE of claim 1, wherein the at least one processor is further operable to execute the instructions to cause the UE to:
receive second control information indicating a set of timing advance values and corresponding sets of resources for receipt of synchronization signal blocks, wherein the corresponding sets of resources include the first resources; and
receive a cell switch command comprising the indication of the transmission configuration indicator state and an indication of a timing advance value from the set of timing advance values, wherein the first control information is based at least in part on the indicated timing advance value corresponding to the first resources for receipt of the synchronization signal block indicated via the second control information.

13. The UE of claim 1, wherein the at least one processor is further operable to execute the instructions to cause the UE to:
receive, via the serving cell, an indication of a channel state information configuration for the reference signal of the candidate cell, wherein the first resources comprise a root quasi co-location source associated with the reference signal, wherein the reference signal is a channel state information reference signal.

14. The UE of claim 1, wherein the one or more messages are communicated using the synchronization signal block as the quasi co-location source for the transmission configuration indicator state based at least in part on the first control information, wherein the at least one processor is further operable to execute the instructions to cause the UE to:
receive, via the candidate cell, a control message indicating the reference signal of the candidate cell; and
communicate one or more additional messages with the candidate cell using the reference signal as the quasi co-location source based at least in part on receiving the control message.

15. The UE of claim 1, wherein the at least one processor is further operable to execute the instructions to cause the UE to:
receive, via the serving cell, a cell switch command indicating for the UE to switch from the serving cell to the candidate cell, wherein the one or more messages are communicated using the synchronization signal block as the quasi co-location source for the transmission configuration indicator state based at least in part on the first control information and the cell switch command;
identify an expiration of a timer based at least in part on receiving the cell switch command; and
communicate one or more additional messages with the candidate cell using the reference signal as the quasi co-location source based at least in part on identifying the expiration of the timer.

16. The UE of claim 15, wherein the at least one processor is further operable to execute the instructions to cause the UE to:
receive, via the serving cell, the candidate cell, or both, an indication of the timer, wherein identifying the expiration of the timer is based at least in part on receiving the indication of the timer.

17. A user equipment (UE), comprising:
at least one processor; and
at least one memory coupled with the at least one processor, the at least one memory storing instructions executable by the at least one processor to cause the UE to:
receive, via a serving cell, an indication of a transmission configuration indicator state for communicating with a candidate cell, wherein the transmission configuration indicator state is associated with a quasi co-location source that indicates that spatial resources used by the UE for communications with the candidate cell are quasi co-located with a synchronization signal block of the candidate cell; and
communicate one or more messages with the candidate cell using the spatial resources, wherein the spatial resources are based at least in part on measurements of the synchronization signal block.

18. The UE of claim 17, wherein the at least one processor is further operable to execute the instructions to cause the UE to:
receive, from the serving cell, a cell switch command indicating for the UE to switch from the serving cell to the candidate cell, wherein communicating the one or more messages is based at least in part on receiving the cell switch command, wherein the indication of the transmission configuration indicator state is received via the cell switch command.

19. The UE of claim 17, wherein the at least one processor is further operable to execute the instructions to cause the UE to:
receive a radio resource control message indicating associations between a set of transmission configuration indicator states and sets of resources for receipt of synchronization signal blocks, wherein the set of transmission configuration indicator states include the indicated transmission configuration indicator state, and wherein the sets of resources include first resources associated with the synchronization signal block, wherein receiving the indication of the transmission configuration indicator state is based at least in part on receiving the radio resource control message.

20. A method for wireless communications at a user equipment (UE), comprising:
receiving, via a serving cell, an indication of a transmission configuration indicator state for communicating with a candidate cell, wherein the transmission configuration indicator state is associated with a quasi co-location source that indicates that spatial resources used by the UE for communications with the candidate cell are quasi co-located with a reference signal of the candidate cell;
receiving, via the serving cell, first control information that is indicative of an association between the transmission configuration indicator state and first resources for receipt of a synchronization signal block from the candidate cell; and
communicating one or more messages with the candidate cell using the spatial resources, wherein the spatial resources are based at least in part on the association between the first resources and the transmission configuration indicator state.
